(19) United States
(12) Patent Application Publication
(10) Pub. No.: US 2026/0172072 A1
(43) Pub. Date: Jun. 18, 2026

(54) ENHANCED SYNCHRONIZATION FOR MULTI-ACCESS POINT COORDINATED BEAMFORMING AND SPATIAL REUSE IN WIRELESS COMMUNICATIONS

(71) Applicant: Intel Corporation, Santa Clara, CA (US)

(72) Inventors: Dmitry Akhmetov, Hillsboro, OR (US); Danny Alexander, Neve Efraim Monoson (IL); Danny Ben-Ari, Hod HaSharon (IL); Laurent Cariou, Milizac (FR); Dibakar Das, Hillsboro, OR (US); Juan Fang, Portland, OR (US); Po-Kai Huang, San Ramon, CA (US); Qinghua Li, San Ramon, CA (US); Shlomi Vituri, Tel Aviv (IL)

(21) Appl. No.: 19/531,400

(22) Filed: Feb. 5, 2026

Related U.S. Application Data
(60) Provisional application No. 63/754,742, filed on Feb. 6, 2025.
(60) Provisional application No. 63/760,513, filed on Feb. 19, 2025.
(60) Provisional application No. 63/766,843, filed on Mar. 4, 2025.

(51) Int. Cl. H04B 7/024; H04W 28/02

(52) U.S. Cl. CPC H04B 7/024; H04W 28/0278

(57) ABSTRACT

This disclosure describes systems, methods, and devices related to enhanced coordinated beamforming and coordinated spatial reuse in wireless communications. A sharing access point may send an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR); and may send, based on the UHR variant BSRP trigger frame, a first downlink physical layer protocol data unit (PPDU) in synchronization with a second downlink PPDU of the shared AP.

### CROSS-REFERENCE TO RELATED PATENT APPLICATION(S)

This application claims the benefit of U.S. Provisional Application No. 63/754,742, filed Feb. 6, 2025, U.S. Provisional Application No. 63/760,513, filed Feb. 19, 2025, and U.S. Provisional Application No. 63/766,843, filed Mar. 4, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network, in accordance with one or more example embodiments of the present disclosure.

FIG. 2 shows an example sequence for a downlink multi-user coordinated beamforming transmission, in accordance with one or more embodiments of the present disclosure.

FIG. 3A shows example orthogonal frequency division multiple access (OFDMA) transmissions acknowledging coordinated beamforming data frames, in accordance with one or more example embodiments of the present disclosure.

FIG. 3B shows example OFDMA transmissions acknowledging coordinated beamforming data frames, in accordance with one or more example embodiments of the present disclosure.

FIG. 4 illustrates a flow diagram of illustrative process for coordinated beamforming and coordinated spatial reuse, in accordance with one or more example embodiments of the present disclosure.

FIG. 5 illustrates a functional diagram of an exemplary communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

FIG. 7 is a block diagram of a radio architecture in accordance with some examples.

FIG. 8 illustrates an example front-end module circuitry for use in the radio architecture of FIG. 7, in accordance with one or more example embodiments of the present disclosure.

FIG. 9 illustrates an example radio IC circuitry for use in the radio architecture of FIG. 7, in accordance with one or more example embodiments of the present disclosure.

FIG. 10 illustrates an example baseband processing circuitry for use in the radio architecture of FIG. 7, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define Wi-Fi® (hereinafter referred to as Wi-Fi) communications, including for coordinated beamforming (CBF/CoBF) and coordinated spatial reuse (SCR/CoSR). CBF and SCR are features in 802.11bn designed to increase network throughput by allowing multiple access points (APs) to transmit simultaneously over a same frequency channel. In CBF, a sharing AP and a shared AP coordinate their transmissions to minimize inter-basic service set (BSS) interference. CSR allows overlapping BSS (OBSS) APs to transmit at the same time by managing interference. Both CBF and CSR rely on a unified signaling structure to facilitate simultaneous transmissions.

OBSS PD-based (preamble detection-based) spatial reuse operations with a spatial reuse field were introduced in 802.11ax, and are defined in Section 26.10.2.2 in 802.11REVme D7.0 as follows: 26.10.2.2 General operation with non-SRG OBSS PD level. If the PHY of a STA issues a PHY-CCA.indication (BUSY) followed by a (#3038) PHY-RXEARLYSIG.indication or PHY-RXSTART.indication due to a PPDU reception, then the STA's MAC sublayer may (#1120)(#1119): a) (#1120) issue a PHY-CCARESET.request primitive before the end of the PPDU and not update its basic NAV timer based on the PPDU, or b) (#1120) treat the PPDU as not having been received for purposes of its basic NAV timer (i.e., not update its basic NAV timer), (#1120) if (for either (a) or (b)) all the following conditions are met: 1) The STA has not set the TXVECTOR parameter SPATIAL_REUSE to the value PSR_AND_NON_SRG_OBSS_PD_PROHIBITED in any HE PPDU it has transmitted in the current beacon period and in the previous beacon period (Related to the STA itself). 2) The most recently received Spatial Reuse Parameter Set element from its associated AP had the Non-SRG OBSS PD SR Disallowed subfield equal to 0, or the non-AP STA has not received a Spatial Reuse Parameter Set element from its associated AP, or the STA is an AP and its most recently transmitted Spatial Reuse Parameter Set element had the Non-SRG OBSS PD SR Disallowed subfield equal to 0, or the STA is an AP and has not transmitted a Spatial Reuse Parameter Set element (Related to the associated AP). 3) The received PPDU is an inter-BSS PPDU (see 26.2.2 (Intra-BSS and inter-BSS PPDU classification)), and the received PPDU is not a non-HT PPDU carrying a response frame (Ack, BlockAck, or CTS frame); or the received PPDU contains a CTS, a PHY-CCA.indication transition from BUSY to IDLE occurred within the PIFS time immediately preceding the received CTS, and that transition corresponded to the end of an inter-BSS PPDU that contained an RTS that was (#3683) discarded following this procedure. 4) The STA is operating with an SRG OBSS PD level as described in 26.10.2.3 (General operation with SRG OBSS PD level), and the received PPDU is not an SRG PPDU; or the STA is not operating with an SRG OBSS PD level (Related to the STA itself). 5) The SPATIAL_REUSE subfield in the HE-SIG-A field (if present) of the received PPDU is not set to PSR_AND_NON_SRG_OBSS_PD_PROHIBITED (not applied if SR is not present). 6) The received signal strength level, which is measured from the L-STF or L-LTF fields of the PPDU or the PHY SYNC field, shortSYNC field, or Long PHY SYNC field, whichever exists and is used to determine PHY-CCA.indication, is below the non-SRG OBSS PD level. The non-SRG OBSS PD level is defined in 26.10.2.4 (Adjustment of OBSS PD and transmit power). If the STA has dot11HEPSROptionImplemented set to true, it also follows the rules defined in 26.10.4 (Interaction of OBSS PD and PSR-based spatial reuse) to determine non-SRG OBSS PD level. 7) The PPDU is not one of the following: *i) A non-HE PPDU that carries a frame where the RA field is equal to the STA MAC address *ii) A non-HE PPDU that carries a Public Action frame *iii) A non-HE PPDU that carries a VHT/HE NDP Announcement frame or FTM frame (#7223) *iv) A non-HE NDP. NOTE: A STA cannot perform SR over an HE sounding NDP or HE TB feedback NDP (see 26.11.6 (SPATIAL_REUSE)).

The above condition 5) above is only applied when the spatial reuse subfield is present. On the other hand, under a PHY VER_UNKNOWN case in 802.11be, the spatial reuse subfield value is decided as “Not Present” as shown in Table 1 below, representing Table 36-1:

TABLE 1
TXVECTOR and RXVECTOR Parameters (continued):

| Parameter | Condition | Value | TXVECTOR | RXVECTOR |
|---|---|---|---|---|
| SPATIAL_{—} | FORMAT is | Indicates the spatial | Y | Y |
| REUSE | EHT_MU | reuse parameter value. | | |
| | | There is one value of | | |
| | | the parameter for an | | |
| | | EHT MU PPDU. See | | |
| | | the Spatial Reuse field | | |
| | | definition 36.3.12.8.3 | | |
| | | (Common field for | | |
| | | OFDMA transmission) | | |
| | | and 36.3.12.8.4 | | |
| | | (Common field for | | |
| | | non-OFDMA | | |
| | | transmission). | | |
| | | Integer in the range 0 to | | |
| | | 15. | | |
| | | See 35.10 (EHT Spatial | | |
| | | reuse operation) and | | |
| | | 35.11.2 | | |
| | | (SPATIAL_REUSE). | | |
| | FORMAT is | Indicates the spatial | Y | Y |
| | EHT_TB | reuse parameter value. | | |
| | | There are one to two | | |
| | | values of the parameter | | |
| | | for an EHT TB PPDU, | | |
| | | with the number of | | |
| | | values present | | |
| | | dependent on the | | |
| | | bandwidth of the | | |
| | | PPDU. See the Spatial | | |
| | | Reuse field definition | | |
| | | in 36.3.12.7.2 | | |
| | | (Content). | | |
| | | For each of the values, | | |
| | | integer in the range 0 to | | |
| | | 15. | | |
| | | See 35.10 (EHT Spatial | | |
| | | reuse operation) and | | |
| | | 35.11.2 | | |
| | | (SPATIAL_REUSE). | | |
| | FORMAT is | Not present. | | |
| | PHY_VER_{—} | | | |
| | UNKNOWN | | | |
| | Otherwise | See corresponding | | |
| | | entry in Table 27-1 | | |
| | | (TXVECTOR and | | |
| | | RXVECTOR | | |
| | | parameters). | | |

As a result, EHT device is allowed to perform OBSS PD-based SR over UHR/UHR+PPDU as shown in following two examples if all other conditions are met, where condition 5) is not applied since UHR/UHR+PPDU is PHY_VER UNKNOWN to the EHT device.

Example 1: Upon reception of an inter-BSS UHR/UHR+MU PPDU and ELR PPDU, the EHT device is allowed to do the OBSS PD-based SR. These should be avoided or under control to protect the UHR MU PPDU or ELR PPDU.

Example 2: Upon reception of a UHR MU PPDU with CoBF enabled, the EHT device associated with the 2nd BSS, whose color is indicated as the 2nd BSS color in the U-SIG, is allowed to do OBSS PD-based SR. These should be avoided or under control to protect the UHR MU PPDU with CoBF enabled.

Following the current OBSS PD-based SR conditions, UHR device is also allowed to do OBSS PD-based SR over ELR PPDU if all other conditions except 5) are met. These should be avoided to protect ELR PPDU or other PPDU defined without SR subfield in the preamble.

Several solutions have been proposed to avoid the above issues. One solution to protect ELR PPDU or other PPDU defined without SR is to strictly define that SR is not allowed by setting the value of Spatial Reuse field to be PSR_AND_NON_SRG_OBSS_PD_PROHIBITED. However, the previous solution permanently disables OBSS_PD based SR over ELR PPDU.

The present disclosure provides another solution that enables flexible SR control over the ELR PPDU. In addition to a CoBF sync frame design, the present disclosure adds information in the trigger frame for the STAs to feedback BA feedback after the reception of the DL MU CoBF PPDU from the two APs.

The present disclosure also proposes how to carry all the required transmission parameters in the trigger frame sent by one of the APs, who has all the parameters for DL MU CoBF PPDU transmission based on collection from coordinated AP, calculation or optimization over known information, and how to map all the information distracted from the received trigger frame to the pre-UHR preamble for the DL MU CoBF PPDU transmission in both two APs.

One proposal of the present disclosure is to control UHR or UHR+device to perform OBSS PD-based SR on UHR ELR PPDU. Table 2 below shows the current defined U-SIG format for the ELR PPDU in Draft P802.11bn D0.1. There are four bits in the U-SIG 1, which can come from the disregard or validate bits, can be used as the Spatial Reuse field.

TABLE 2
U-SIG Format for UHR ELR PPDU:

| | | | | | | | |
|---|---|---|---|---|---|---|---|
| U-SIG1 | PHY | PPDU | UL/DL | BSS | TXOP | Disregard | Validate |
| Field: | Version | BW | | Color | | | |
| | (set to 1) | | | | | | |
| Bits: | B0-B2 | B3-B5 | B6 | B7-B12 | B13-B19 | B20-B24 | B25 |

| | | | | | |
|---|---|---|---|---|---|
| U-SIG2 | PPDU | STA-ID | ELR | CRC | Tail |
| Field: | Type (set | | Validate | | |
| | to 3) | | | | |
| Bits: | B0-B1 | B2-B12 | B13-B15 | B16-B19 | B20-B25 |

Table 3 below shows a designed example with 4-bit spatial reuse field in the U-SIG of UHR ELR PPDU.

TABLE 3
Proposed U-SIG Format for UHR ELR PPDU with Spatial Reuse Field:

| | | | | | | | | |
|---|---|---|---|---|---|---|---|---|
| U- | PHY | PPDU | UL/DL | BSS | TXOP | Spatial | Disregard | Validate |
| SIG1 | Version | BW | | Color | | Reuse | | |
| Field: | (set to 1) | | | | | | | |
| Bits: | B0-B2 | B3-B5 | B6 | B7-B12 | B13-B19 | B20-B23 | B24 | B25 |

| | | | | | |
|---|---|---|---|---|---|
| U- | PPDU | STA-ID | ELR | CRC | Tail |
| SIG2 | Type (set | | Validate | | |
| Field: | to 3) | | | | |
| Bits: | B0-B1 | B2-B12 | B13-B15 | B16- | B20-B25 |
| | | | | B19 | |

Table 4 below shows the current UHR Variant Common field format in the trigger frame defined in Draft P802.11bn_D0.1, where UL Spatial Reuse subfield is marked as TBD, which may be kept the same as in EHT or removed for other purposes or being as reserved bits. B56-B59 are used to indicate whether each 80 MHz subblock is using distributed RU or regular RU, B60 is used to indicate whether IFCS is presented or not, B62-B62 will be reserved for UHR, all other fields are kept the same as that in EHT.

TABLE 4
UHR Variant Common Info Field Format:

| | | | | | | | |
|---|---|---|---|---|---|---|---|
| Field: | Trigger | UL | More TF | CS | UL BW | GI and | Reserved |
| | Type | Length | | Required | | HE/UHR- | |
| | | | | | | LTF Type/ | |
| | | | | | | TXS Mode | |
| Bits: | B0-B3 | B4-B15 | B16 | B17 | B18- | B20-B21 | B22 |
| | | | | | B19 | | |
| Field: | Number | Reserved | LDPC | AP TX | Pre-FEC | PE | UL |
| | of | | Extra- | Power | Padding | Disambiguity | Spatial |
| | HE/UH | | Symbol | | Factor | | Reuse |
| | R-LTF | | Segment | | | | |
| | Symbols | | | | | | |
| Bits: | B23- | B26 | B27 | B28-B33 | B34- | B36 | B37-B52 |
| | B25 | | | | B35 | | |
| Field: | Reserve | HE/UHR | Special | DUR/ | IFCS | UHR | Reserved |
| | | P160 | User | RRU | Present | Reserved | |
| | | | Info | Indication | Flag | | |
| | | | Field | | | | |
| | | | Flag | | | | |
| Bits: | B53 | B54 | B55 | B56-B59 | B60 | B61-B62 | B63 |

| | |
|---|---|
| Field: | Trigger Dependent Common Info |
| Bits: | Variable |

Table 5 below shows the current special user info format in the trigger frame defined in Draft P802.11bn D0.1, which is the same as that in EHT with the two Spatial Reuse subfields are to be TBD, which may be removed or kept the same as that defined in EHT.

TABLE 5
Special User Info Field Format:

| | | | | | | | |
|---|---|---|---|---|---|---|---|
| Field: | AID | PHY | UL BW | EHT/ | EHT/ | U-SIG | Reserved |
| | | Version | Extension | UHR | UHR | Disregard | |
| | | Number | | Spatial | Spatial | and | |
| | | | | Reuse 1 | Reuse 2 | Validate | |
| Bits: | B0-B11 | B12-B14 | B15-B16 | B17- | B21- | B25-B36 | B37-B39 |
| | | | | B20 | B24 | | |

| | |
|---|---|
| Field: | Trigger Dependent User Info |
| Bits: | Variable |

Table 6 below shows the current UHR user info field format in the Trigger frame defined in Draft P802.11bn D0.1.

TABLE 6
UHR User Info Field Format:

| | | | | | | | |
|---|---|---|---|---|---|---|---|
| Field: | AID12 | RU | UL FEC | UL | 2x | SS | UL |
| | | Allocation | Coding | UHR- | LDPC | Allo- | Target |
| | | | Type | MCS | | cation | Receive |
| | | | | | | | Power |
| Bits: | B0-B11 | B12-B19 | B20 | B21- | B26 | B27- | B32- |
| | | | | B25 | | B31 | B38 |

| | | |
|---|---|---|
| Field: | PS160 | Trigger Dependent User Info |
| Bits: | B39 | Variable |

The present disclosure proposes the following options for CoBF sync frames:

Option 1: The trigger frame will include the UHR variant common info field, Special User info field, UHR User info field with AID as the shared AP to carry some information used in the U-SIG of the DL MU CoBF PPDU, then following with the UHR user info field with AID as the non-AP STA, which is the receiver of the DL MU CoBF PPDU.

TABLE 7
Option 1 for UHR Variant Common Info Field:

| Bits: | Contents: |
|---|---|
| B0-B3 | Trigger Type: BSRP trigger type may be reused for CoBF sync or CoBF |
| | invite frame, or defined as a new trigger type. |
| B4-B15 | Length: Repurposed from UL Length to the Length field in the L-SIG of the |
| | DL MU CoBF PPDU. |
| B16 | Kept the same definition. |
| B17 | Kept the same definition. |
| B18-B19 | UL BW: Jointly indicates PPDU BW in the U-SIG of the DL MU CoBF |
| | PPDU alongside the UL Bandwidth Extension subfield. |
| B20-B21 | GI and HE/UHR-LTF Type/TXS Mode: Used to indicate GI and LTF size in |
| | the DL MU CoBF PPDU and/or BA feedback to APs. |
| B22 | Kept the same or used to indicate if it is a CoBF or CoSR sync frame. |
| B23-B25 | Number of UHR-LTF Symbols: Indicates the number of UHR-LTF symbols |
| | in the DL MU CoBF PPDU. |
| B26 | Kept the same definition. |
| B27 | Kept the same, repurposed for other indication, or a reserved bit if fixed to 1. |
| B28-B33 | AP TX Power: Used for shared AP TX power, repurposed for other |
| | indication, or reserved bits. |
| B34-B35 | Kept the same, repurposed for other indication, or reserved bits if fixed to 4. |
| B36 | Kept the same definition. |
| B37-B52 | Kept the same, repurposed for other functions, or reserved bits if fixed to |
| | disabled. |
| B53 | Kept the same definition. |
| B54 | Kept the same definition. |
| B55 | Kept the same definition. |
| B56-B59 | DRU/RRU Indication. |
| B60 | IFCS Present Indication. |
| B61-B62 | UHR Reserved. |

For the Special User Info Field: AID as 2007, PHY version identifier: 1, UL Bandwidth extension will be with the UL BW subfield in the UHR variance common info field to jointly indicate the PPDU BW in U-SIG of the DL MU CoBF PPDU. EHT/UHR spatial reuse 1: kept the same to carry the Spatial Reuse 1 value in U-SIG field of the BA or maybe repurposed for other indication or as reserved bits if it is fixed to be disabled. EHT/UHR spatial reuse 2: kept the same to carry the Spatial Reuse 2 value in U-SIG field of the BA or maybe repurposed for other indication or as reserved bits if it is fixed to be disabled. For U-SIG Disregard and Validate field: B0-B5: BSS color of the sharing AP which will be indicated in the B20-B25 in the U-SIG1 of the DL MU CoBF PPDU. B6: CoBF/CoSR indication, which will be indicated in the B2 in the U-SIG2 of the DL MU CoBF PPDU. B7-B11: Number of UHR-SIG symbols, which will be indicated in the B11-B15 in the U-SIG2 of the DL MU CoBF PPDU. B37-B39: reserved or maybe used to indicate whether it is CoBF or CoSR type1 or type 2 or whether it is CoBF/CoSR invite, response or sync. B23-B25: Number of HE/UHR-LTF symbols in the DL MU CoBF PPDU.

For the UHR Variant User Info with AID as the shared AP: B0-B11: the AID of the shared AP assigned by the sharing AP. The rest of the bits in this User field may carry: 3-bit number of CoBF users in the DL MU COBF PPDU, 5-bit puncturing channel information of the DL MU COBF PPDU, BA type in response to the DL MU CoBF PPDU, number of OFDM symbols for the BA in response to the DL MU CoBF PPDU, one sync_reference or follower indication bit, TXOP for the DL MU CoBF PPDU, 2 bit multiple AP coordination type indication such as CoBF or CoSR type I or CoSR type 2, 1 or 2 bit CoBF/CoSR invite/response/sync indication, 6 bit BSS color of the sharing AP and etc. one example format as shown below: B12-B19: 3 bit for number of CoBF users and 5 bit for puncturing channel information. B20: sync follower or reference indication. B21-B26: reserved or BSS color of the sharing AP. B27-B31: 3 bits will be used to indicate the number of UHR-LTF symbols in the BA and the rest will be kept as reserved bits. B32-B38: TXOP for the DL MU CoBF PPDU. B39: reserved.

For the UHR Variant User Info field for the non-AP STA: AID12: First or last 11 bit as the STA ID of the non-AP STA. RU Allocation: assigned RU/MRU for the BA of this STA or the assigned total RU/MRU for the BA of all the STAs associated with the shared AP in response to the DL MU CoBF PPDU. B20: BSS color differentiation. B21-B25: UHR-MCS for the DL CoBF PPDU. B26: 2×LDPC. B27-B31: SS Allocation for DL MU COBF PPDU. B32-B38: 5 bits for number of OFDM symbols for UL BA in response to the DL MU CoBF PPDU, 1 or 2 bits for BA type indication. PS160: together with the RU Allocation to indicate the assigned RU for the BA.

Table 8 is an example UHR Variant Common field.

TABLE 8
UHR Variant Common Field Format:

| | | | | | | | |
|---|---|---|---|---|---|---|---|
| Field: | Trigger | L Length | More TF | CS | UL BW | GI and | Reserved |
| | Type | | | Required | | HE/UHR- | |
| | | | | | | LTF Type | |
| Bits: | B0-B3 | B4-B15 | B16 | B17 | B18- | B20-B21 | B22 |
| | | | | | B19 | | |
| Field: | Number | Reserved | LDPC | AP TX | Pre-FEC | PE | UL |
| | of | | Extra- | Power | Padding | Disambiguity | Spatial |
| | HE/UH | | Symbol | | Factor | | Reuse |
| | R-LTF | | Segment | | | | |
| | Symbols | | | | | | |
| Bits: | B23- | B26 | B27 | B28-B33 | B34- | B36 | B37-B52 |
| | B25 | | | | B35 | | |
| Field: | Reserve | HE/UHR | Special | DUR/ | IFCS | UHR | Reserved |
| | | P160 | User | RRU | Present | Reserved | |
| | | | Info | Indication | Flag | | |
| | | | Field | | | | |
| | | | Flag | | | | |
| Bits: | B53 | B54 | B55 | B56-B59 | B60 | B61-B62 | B63 |

Table 9 is an example Special User Info Field format.

TABLE 9
Special User Info Field Format:

| | | | | | | | |
|---|---|---|---|---|---|---|---|
| Field: | AID | PHY | UL BW | EHT/ | EHT/ | U-SIG | Reserved |
| | | Version | Exten- | UHR | UHR | Disregard | |
| | | Number | sion | Spatial | Spatial | and | |
| | | | | Reuse 1 | Reuse 2 | Validate | |
| Bits: | B0- | B12- | B15- | B17- | B21- | B25-B36 | B37-B39 |
| | B11 | B14 | B16 | B20 | B24 | | |

Table 10 is an example UHR User Info Field format with AID as the shared AP.

TABLE 10
UHR User Info Field Format with AID as Shared AP:

| | Field: | | | | |
|---|---|---|---|---|---|
| | | RU Allocation | Sync_{—} | 3 bit for the | |
| | AID12 | 5 bit Puncturing | Reference | number of UHR | |
| | for | Channel + 3 bit | or Sync_{—} | LTF symbols in | |
| | Shared | number of users | Follower for | the BA + 2 | TXOP for DL |
| | AP | for DL CoBF PPDU | DL CoBF PPDU | reserved bits | CoBF PPDU |
| Bits: | B0-B11 | B12-B19 | B20-B26 | B27-B31 | B32-B38 |

Table 11 is an example UHR User Info Field format with AID as the non-AP STA (receiver of the DL MU CoBF PPDU).

TABLE 11
UHR User Info Field format with AID as the non-AP STA:

| | | | | | | |
|---|---|---|---|---|---|---|
| Field: | AID12 | RU | BSS Color | UL | 2x | SS Allocation |
| | for BA | Allocation | Differ- | UHR- | LDPC | for DL |
| | and DL | for BA | entiation | MCS | for DL | CoBF PPDU |
| | CoBF | | | for DL | CoBF | |
| | PPDU | | | CoBF | PPDU | |
| | | | | PPDU | | |
| Bits: | B0-B11 | B12-B19 | B20 | B21- | B26 | B27-B31 |
| | | | | B25 | | |

| | | |
|---|---|---|
| Field: | Number of OFDM Symbols for UL BA + 1 | PS160 for BA |
| | or 2 bits for BA Type | |
| Bits: | B32-B38 | B32-B38 |

In a second option, the trigger frame may include the UHR variant common info field, Special User info field, UHR User info field with AID as the non-AP STA, which is the receiver of the DL MU CoBF PPDU. Table 12 shows an example UHR variant common info field in Option 2.

TABLE 12
Option 2 for UHR Variant Common Info Field:

| Bits: | Contents: |
|---|---|
| Bit(s) | Content Description |
| B0-B3 | Trigger type: BSRP trigger type may be reused for CoBF sync |
| | or CoBF invite frame, or be defined as a new trigger type. |
| B4-B15 | UL Length: Repurposed as the Length field in the L-SIG in |
| | the DL MU CoBF PPDU. |
| B16 | Kept the same definition. |
| B17 | Kept the same definition. |
| B18-B19 | UL BW: Jointly indicates the PPDU BW in the U-SIG of the |
| | DL MU CoBF PPDU (used with the UL Bandwidth Extension |
| | subfield in the special User Info field). |
| B20-B21 | GI and HE/UHR-LTF Type/TXS Mode: Used to indicate the |
| | GI and LTF size in the DL MU CoBF PPDU and/or the BA |
| | feedback to the APs. |
| B22 | Kept the same or used to indicate it is a CoBF or CoSR sync |
| | frame. |
| B23-B25 | Used to indicate the number of UHR-LTF symbols in the DL |
| | MU CoBF PPDU. |
| B26 | Kept the same definition. |
| B27 | Kept the same or repurposed for other indication (or reserved |
| | bit if fixed to 1). |
| B28-B33 | AP tx Power: Kept the same and used for shared AP TX |
| | power, repurposed for other indication, or reserved bits. |
| B34-B35 | Kept the same or repurposed for other indication (or reserved |
| | bits if fixed to 4). |
| B36 | Kept the same definition. |
| B37-B52 | Kept the same or repurposed for other functions indication (or |
| | reserved bits if fixed to be disabled). |
| B53 | Kept the same definition. |
| B54 | Kept the same definition. |
| B55 | Kept the same definition. |
| B56-B59 | DRU/RRU indication. |
| B60 | IFCS present indication. |
| B61-B62 | UHR Reserved |
| B63 | Reserved |

For the special user info field: B0-B11: AID as 2007, B12-B14: PHY version identifier:

B15-B16: UL Bandwidth extension will be with the UL BW subfield in the UHR variance common info field to jointly indicate the PPDU BW in U-SIG of the DL MU CoBF PPDU. B17-B20: EHT/UHR spatial reuse 1: kept the same to carry the Spatial Reuse 1 value in U-SIG field of the BA or maybe repurposed for other indication or as reserved bits if it is fixed to be disabled. B21-B24: EHT/UHR spatial reuse 2: kept the same to carry the Spatial Reuse 2 value in U-SIG field of the BA or maybe repurposed for other indication or as reserved bits if it is fixed to be disabled. B25-B36: U-SIG Disregard and Validate: B0-B5: BSS color of the sharing AP which will be indicated in the B20-B25 in the U-SIG1 of the DL MU CoBF PPDU. B6: CoBF/CoSR indication, which will be indicated in the B2 in the U-SIG2 of the DL MU CoBF PPDU. B7-B11: number of UHR-SIG symbols, which will be indicated in the B11-B15 in the U-SIG2 of the DL MU CoBF PPDU. B37-B39: reserved or maybe used to indicate whether it is CoBF or CoSR type1 or type 2 or whether it is CoBF/CoSR invite, response or sync. B23-B25: Number of HE/UHR-LTF symbols in the DL MU CoBF PPDU.

For the UHR variant user info field for the non-AP STA associated to the sharing AP: B0-B11: AID12: First or last 11 bit as the STA ID of the non-AP STA. B12-B14: number of CoBF users in the DL MU COBF PPDU. B15-B19: puncturing channel information of the DL MU COBF PPDU, B20: BSS color differentiation. B21-B25: UHR-MCS for the DL CoBF PPDU. B26: 2×LDPC. B27-B31: SS Allocation for DL MU COBF PPDU. B32-B38: TXOP or reserved bits. PS160: reserved bit.

For the UHR Variant User Info field for the non-AP STA associated to the shared AP: B0-B11: AID12: First or last 11 bit as the STA ID of the non-AP STA. B12: B19: RU Allocation: assigned RU/MRU for the BA of this STA or the assigned total RU/MRU for the BA of all the STAs associated with the shared AP in response to the DL MU CoBF PPDU. B20: BSS color differentiation. B21-B25: UHR-MCS for the DL CoBF PPDU. B26: 2×LDPC. B27-B31: SS Allocation for DL MU COBF PPDU. B32-B38: 5 bit number of OFDM Symbols for BA, 1 or 2 bits for BA type or BSS color indication (BSS color 1 or BSS color 2) in the U-SIG of the BA frame or two bit as the number of UHR-LTF in the BA frame. PS160: together with the RU Allocation to indicate the assigned RU for the BA.

The revered bits or some field that is not needed such as AP tx Power, LDPC extra symbol segment, Pre-FEC padding factor, Spatial reuse field in the common info or special user info field, or the RU Allocation field, UL Target Receive power and PS160 in the UHR User info field for the STA associated with the sharing AP and UL Target Receiver power in the UHR User info field for the STA associated with the shared AP will be used to carry for the following information: 5 bit number of OFDM symbols for the BA in response to the DL MU CoBF PPDU. 3 bit the number of the UHR-LTF symbols for the BA. 3-bit number of CoBF users in the DL MU COBF PPDU, 5-bit puncturing channel information of the DL MU COBF PPDU, TXOP for the DL MU CoBF PPDU, one sync_reference or follower indication bit, BA type in response to the DL MU CoBF PPDU, 2 bit multiple AP coordination type indication such as CoBF or CoSR type I or CoSR type 2, 1 or 2 bit CoBF/CoSR invite/response/sync indication, 6 bit BSS color of the sharing AP and etc.

Table 13 below is a design example of a UHR variant common field format.

TABLE 13
UHR Variant Common Field Format:

| | | | | | | | |
|---|---|---|---|---|---|---|---|
| Field: | Trigger | L Length | More TF | CS | UL BW | GI and | Reserved |
| | Type | | | Required | | HE/UHR- | |
| | | | | | | LTF Type | |
| Bits: | B0-B3 | B4-B15 | B16 | B17 | B18- | B20-B21 | B22 |
| | | | | | B19 | | |
| Field: | Number | Reserved | LDPC | AP TX | Pre-FEC | PE | UL |
| | of | | Extra- | Power | Padding | Disambiguity | Spatial |
| | HE/UH | | Symbol | | Factor | | Reuse |
| | R-LTF | | Segment | | | | |
| | Symbols | | | | | | |
| Bits: | B23- | B26 | B27 | B28-B33 | B34- | B36 | B37-B52 |
| | B25 | | | | B35 | | |
| Field: | Reserve | HE/UHR | Special | DUR/ | IFCS | UHR | Reserved |
| | | P160 | User Info | RRU | Present | Reserved | |
| | | | Field Flag | Indication | Flag | | |
| Bits: | B53 | B54 | B55 | B56-B59 | B60 | B61-B62 | B63 |

Table 14 is an example special user info field format.

TABLE 14
Special User Info Field Format:

| | | | | | | | |
|---|---|---|---|---|---|---|---|
| Field: | AID | PHY | UL BW | EHT/ | EHT/ | U-SIG | Reserved |
| | | Version | Exten- | UHR | UHR | Disregard | |
| | | Num- | sion | Spatial | Spatial | and | |
| | | ber | | Reuse 1 | Reuse 2 | Validate | |
| Bits: | B0- | B12- | B15- | B17- | B21- | B25-B36 | B37-B39 |
| | B11 | B14 | B16 | B20 | B24 | | |

B17-B20 and B21-B24 of Table 14 may carry the values to be included in the corresponding Spatial Reuse1 or 2 field in the U-SIG of the BA which will be sent SIFS time after the end of the DL MU CoBF PPDU. If SR is fixed to be disabled, some of these bits with the rest reserved bits can be repurposed to indicate the MAP type (CoBF, CoSR type I or CoSR type II), CoBF/CoSR invite/response/sync frame, the number of the UHR-LTF symbols for the BA and etc.

Table 15 shows an example UHR variant user info field format for STAs associated to a sharing AP.

TABLE 15
UHR Variant User Info Field Format for STAs associated to a sharing AP:

| | Field: | | | | |
|---|---|---|---|---|---|
| | | 3 bit number | | | |
| | | of CoBF | | | |
| | AID12 for | users + 5 bit | | UL UHR- | 2x LDPC |
| | BA and DL | puncturing | BSS Color | MCS for DL | for DL |
| | CoBF PPDU | channel info | Differentiation | CoBF PPDU | CoBF PPDU |
| Bits: | B0-B11 | B12-B19 | B20 | B21-B25 | B26 |

| | Field: | | |
|---|---|---|---|
| | SS Allocation | | |
| | for DL CoBF | | |
| | PPDU | TXOP | Reserved |
| Bits: | B27-B31 | B32-B38 | B39 |

Table 16 shows an example UHR variant user info field format for STAs associated to a shared AP.

TABLE 16
UHR Variant User Info Field Format for STAs associated to a shared AP:

| | Field: | | | | |
|---|---|---|---|---|---|
| | AID12 for BA | RU | | UL UHR- | 2x LDPC |
| | and DL CoBF | Allocation | BSS Color | MCS for DL | for DL |
| | PPDU | for BA | Differentiation | CoBF PPDU | CoBF PPDU |
| Bits: | B0-B11 | B12-B19 | B20 | B21-B25 | B26 |

| | Field: | | |
|---|---|---|---|
| | | 5-bit number | |
| | SS | of OFDM | |
| | Allocation | symbols for | |
| | for DL CoBF | BA + 1 or 2 | PS160 |
| | PPDU | bits for BA Type | for BA |
| Bits: | B27-B31 | B32-B38 | B39 |

The LDPC extra symbol segment in the BA may be fixed to 1 and the pre-FEC padding factor in the BA may be fixed to be 4.

For the acknowledgement of the CBF data frames, the sharing AP may allocate frequency resources to the shared AP in the trigger (or synch) frame. The Ack or Block Ack (BA) may be sent in uplink OFDMA mode by the STA. The OFDMA resource allocation may be indicated in the trigger/synch frame right before the CBF Data transmission. The resource allocation, e.g., the bandwidth or RU allocation, may be indicated in the RU allocation subfield of the user info field of the trigger frame. The sharing AP may allocate the RU allocation for the scheduled STAs of both sharing AP and shared AP. There are multiple options for the OFDMA transmission as discussed further below.

In Option (a), both the preamble and the associated data OFDM symbols are within a portion of the band, e.g., a subchannel or resource unit (RU). The preambles of different STAs can be different. For example, the BSS color in Preamble 1 may be set by a STA of sharing AP to the BSS color of the sharing AP and the BSS color in Preamble 2 may be set by a STA of the shared AP to the BSS color of the shared AP. In Option (b), the preamble is of full bandwidth and the data OFDM symbols of different STAs are sent in different portions of the band, e.g., different subchannels or RUs. Because the preamble signal of each STA is the same, the BSS color in the preamble may be set to the BSS color of the sharing AP (or the shared AP). Option (b) provides a higher granularity of RU allocation than Option (a). For example, a 60 MHz channel is shared by two APs. In Option (a), one AP gets 40 MHz and the other gets 20 MHz. In Option (b), there are four 106-tone-RUs in 60 MHz. Each AP can get 3 106-tone-RUs. Namely, the frequency resource can be divided more evenly among the APs for the Ack or BA uplink transmissions. Because the Ack or BA transmission duration is the same for all the CBF STAs, the finer RU granularity the evener resource allocation and the less the resource is wasted. Besides the BSS color setting, other parameters in the uplink PPDU preamble may be specified by the sharing AP in the trigger frame as well, e.g., the Length field in the L-SIG. The duration of the uplink transmission needs to be specified or derived from some parameter(s) in the CBF trigger/synch frame.

In an example sequence for DL MU CoBF transmissions, there may be multiple main handshakes or steps. 1st step: The sharing AP will send CoBF invite frame to the shared AP with the CoBF invitation request, including the candidate or participating CoBF STA information, such as STA-ID, buffer status, number of assigned spatial streams, length, etc.

2nd step: The shared AP will based on the information shared by the sharing AP to select the candidate or participating CoBF STA with the related transmission parameters, then respond to the CoBF invitation request with confirmation and the candidate or participating CoBF STA information including the STA-ID, MCS, whether 2×LDPC is used or not, LDPC extra symbol segment, LDPC pre-FEC padding factor and PE Disambiguity based on Length information with the data rate, number of spatial streams and etc.

3rd step: the sharing AP will analyze all the collected information and determine the final transmission parameters for the DL MU CoBF transmission, which will include: a length field in the L-SIG of the DL MU PPDU, and fields in the U-SIG of the DL MU PPDU as shown in Table 17 below.

TABLE 17
U-SIG Format Defined for MU-PPDU in 802.1bn v0.1:

| U- | PHY | PPDU | UL/DL | BSS | TXOP | BSS Color 2 | | |
|---|---|---|---|---|---|---|---|---|
| SIG1 | Version | BW | | Color | | | | |
| Field: | (set to | | | 1 | | | | |
| | 1) | | | | | | | |
| Bits: | B0-B2 | B3-B5 | B6 | B7- | B12- | B20-B25 | | |
| | | | | B12 | B19 | | | |
| U- | PPDU | CoBF/ | Punc- | Vali- | UHR- | Number | CRC | Tail |
| SIG2 | Type | CoSR | tured | date | SIG | of | | |
| Field: | | | Channel | | MCS | UHR- | | |
| | | | Info | | | SIG | | |
| | | | | | | Sym- | | |
| | | | | | | bols | | |
| U- | B0-B1 | B2 | B3-B7 | B8 | B9- | B11- | B16- | B20- |
| SIG1 | | | | | B10 | B15 | B19 | B25 |
| Field: | | | | | | | | |

Table 18 below shows a UHR-SIG format defined for DL MU-PPDU transmission in 802.11bn v0.1.

TABLE 18
UHR-SIG Format Defined for MU-PPDU in 802.1bn v0.1:

| | Common field for non-OFDMA transmission: | | | | |
|---|---|---|---|---|---|
| | | | | LDPC | |
| | | | Number of | Extra | Pre-FEC |
| | Spatial | GI + LTF | UHR-LTF | Symbol | Padding |
| | Reuse | Size | Symbols | Segment | Factor |
| Bits: | B0-B3 | B4-B5 | B6-B8 | B9 | B10-B11 |

| | Common field for non-OFDMA transmission: | | | |
|---|---|---|---|---|
| | PE | | | Number of non- |
| | Disambiguity | IM | Disregard | OFDMA Users |
| Bits: | B12 | B13 | B14-B15 | B16-B18 |

User Field Format for MU-MIMO Allocation:

| | | | Spatial | |
|---|---|---|---|---|
| | STA-ID | MCS | Reconfiguration | Res |
| Bits: | B0-B10 | B11-B15 | B16-B19 | B20 |

User Field Format for MU-MIMO Allocation:

| | BSS Color Differentiation | 2x LDPC |
|---|---|---|
| Bits: | B21 | B22 |

After that, the sharing AP will carry all the determined parameters for DL MU CoBF data transmission in the CoBF-trigger frame following the current defined trigger frame format in 802.11bn v0.1, which includes the UHR variant Common Info field, Special User Info field and the UHR variant User Info field:

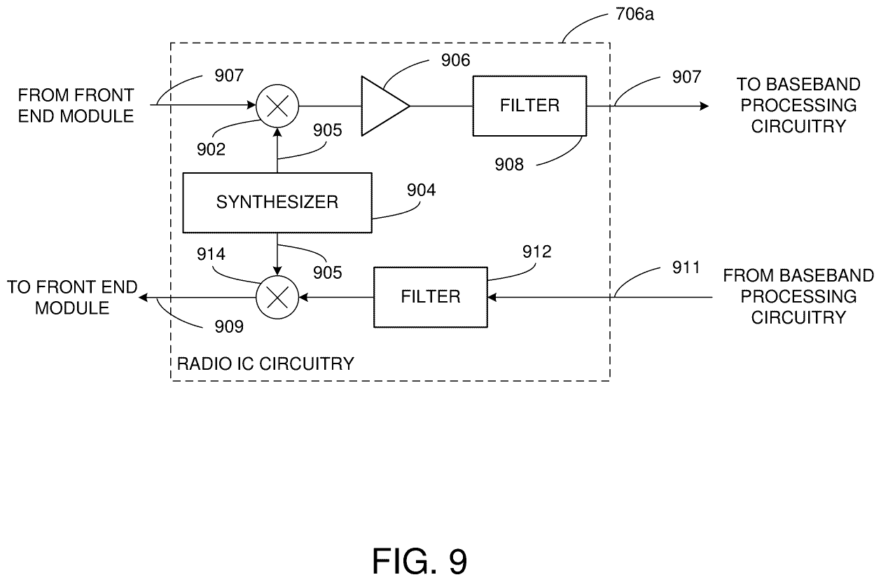

TABLE 19
UHR Variant Common Info Field Format (FIG. 9-90x of 802.11be):

| | | | | | | | |
|---|---|---|---|---|---|---|---|
| Field: | Trigger | UL | More | CS | UL BW | GI and | Reserved |
| | Type | Length | TF | Required | | HE/URH- | |
| | | | | | | LTF Type | |
| | | | | | | TXS Mode | |
| Bits: | B0-B3 | B4-B15 | B16 | B17 | B18- | B20-B21 | B22 |
| | | | | | B19 | | |
| Field: | Number | Reserved | LDPC | AP Tx | Pre- | PE | UL |
| | of | | Extra | Power | FEC | Disambiguity | Spatial |
| | HE/UHR- | | Symbol | | Padding | | Reuse |
| | LTF | | Segment | | Factor | | |
| | Symbols | | | | | | |
| Bits: | B23-B25 | B26 | B27 | B28-B33 | B34- | B36 | B37-B52 |
| | | | | | B35 | | |
| Field: | Reserved | HE/UHR | Special | DRU/ | IFCS | UHR | Reserved |
| | | P160 | User | RRU | Present | Reserved | |
| | | | Info | Indication | Flag | | |
| | | | Field | | | | |
| | | | Flag | | | | |
| Bits: | B53 | B53 | B55 | B56-B59 | B60 | B61-B62 | B63 |

Table 20 shows an example Special User Info field format based on FIG. 9-90d of 802.11be.

TABLE 20
Special User Info Field Format (FIG. 9-90d):

| | | | | | | | |
|---|---|---|---|---|---|---|---|
| Field: | AID12 | PHY | UL BW | EHT/ | EHT/ | U-SIG | Reserved |
| | | Ver- | Exten- | UHR | UHR | Disregard | |
| | | sion | sion | Spatial | Spatial | and | |
| | | ID | | Reuse 1 | Reuse 2 | Validate | |
| Bits: | B0-B11 | B12- | B15- | B17- | B21- | B25-B36 | B37-B39 |
| | | B14 | B16 | B20 | B24 | | |

| | |
|---|---|
| Field: | Trigger Dependent User Info |
| Bits: | Variable |

Table 21 shows an example UHR Variant User Info field format.

TABLE 21
UHR Variant User Info Field Format (FIG. 9-C):

| | | | | | | | |
|---|---|---|---|---|---|---|---|
| Field: | AID12 | RU | UL FEC | UL | 2xLD | SS | UL |
| | | Allocation | Coding | UHR- | PC | Allo- | Target |
| | | | Type | MCS | | cation | RX |
| | | | | | | | Power |
| Bits: | B0-B11 | B12-B19 | B20 | B21-B25 | B26 | B27- | B32- |
| | | | | | | B31 | B38 |

| | | |
|---|---|---|
| Field: | PS160 | Trigger Dependent User Info |
| Bits: | B39 | Variable |

The following two tables showing the detail mapping from the related subfield in the CoBF trigger frame to the subfield in the L-SIG, U-SIG and UHR-SIG field of the solicited DL UHR MU PPDU with CoBF enabled from two coordinated APs:

The Length field in L-SIG of DL MU CoBF PPDU will be carried in the UL Length subfield in UHR variant common Info field of the CoBF trigger frame.

The PHY version in U-SIG of DL MU CoBF PPDU will be carried in the PHY version Identifier in Special User Info Field of the CoBF trigger frame.

The PPDU BW in U-SIG of DL MU CoBF PPDU will be jointly indicated by the UL Bandwidth Extension subfield in the special User Info field together with the UL BW subfield in the UHR variant Common Info field in the CoBF trigger frame.

The UL/DL in U-SIG of DL MU CoBF PPDU will be fixed to be “DL”.

The BSS color 1 in-SIG of DL MU CoBF PPDU will be set to be the BSS color of the sharing AP, it may be carried in certain field in the CoBF trigger frame for simplicity, such as spatial reuse subfields or reserved subfields in the special user info field of the CoBF trigger frame, or reserved subfields in the UHR variant Common Info field of the CoBF trigger frame.

The TXOP in U-SIG of DL MU CoBF PPDU may be fixed to be 127 or will be indicated by Repurposing the spatial reuses subfields in the Special User Info field of the CoBF trigger frame or UL Target Receive power subfields in the UHR Variant User Info field of the CoBF trigger frame as the TXOP.

The BSS color 2 in U-SIG of DL MU CoBF PPDU will be carried by the first 6 bits in the U-SIG Disregard and Validate in the Special User Info field of the CoBF trigger frame.

The PPDU type in U-SIG of DL MU CoBF PPDU will be set to be SU.

The CoBF/CoSR indication bit in U-SIG of DL MU CoBF PPDU will be carried in the 7th bit in the U-SIG Disregard and Validate in the Special User Info field of the CoBF trigger frame.

The Puncturing channel information will be carried in the RA Allocation subfield in UHR Variant User Info field of the CoBF trigger frame.

The UHR-SIG MCS in U-SIG of DL MU CoBF PPDU can be fixed to “0” for simplicity or be indicated by some reserved bits in the UHR variant Common Info or special User Info field of the CoBF trigger frame.

The number of UHR-SIG symbols in U-SIG of DL MU CoBF PPDU will be calculated by the sharing AP and be carried in the last 5 bit in U-SIG Disregard and Validate in Special User Info field of the CoBF trigger frame.

TABLE 22
Trigger Frame Subfields and Corresponding
Subfield of U-SIG in UHR MU CoBF PPDU:

| | Subfield of U-SIG in | |
|---|---|---|
| Subfields in trigger frame | UHR MU CoBF PPDU | |
| UL Length in UHR variant common Info field | L-SIG | Length in L-SIG |
| PHY version Identifier in Special User Info Field | U-SIG | PHY version |
| UL BW in UHR variant common Info field + UL | | PPDU BW |
| Bandwidth Extension in Special User Info field | | |
| | | UL/DL(DL) |
| | | BSS color 1(Sharing |
| | | AP's BSS color) |
| Repurpose the spatial reuses subfields in the Special | | TXOP(or fix to127) |
| User Info field or UL Target Receive power subfields | | |
| UHR Variant User Info field as the TXOP | | |
| U-SIG Disregard and Validate in Special User Info | | BSS color 2 |
| field (B0-B5) | | |
| | | PPDU Type (SU) |
| U-SIG Disregard and Validate in Special User Info | | CoBF/CoSR |
| field (B6) | | |
| RA Allocation in UHR Variant User Info field | | Punctured Channel |
| | | Information |
| | | UHR-SIG MCS (Fix to |
| | | 0) |
| U-SIG Disregard and Validate in Special User Info | | Number of UHR-SIG |
| field (B7-B11) | | Symbols |

The Spatial reuse subfield in UHR-SIG common field of DL MU CoBF PPDU will be set to “PSR_AND_NON_SRG OBSS_PD PROHIBITED”.

The GI+LTF size in UHR-SIG common field of DL MU CoBF PPDU will be carried by the GI And HE/UHR-LTF Type/TXS mode subfield in UHR variant common Info field of the CoBF-trigger frame.

The number of UHR-LTF Symbols in UHR-SIG common field of DL MU CoBF PPDU will be carried by the Number of HE/UHR-LTF Symbols subfield in UHR variant common Info field of the CoBF-trigger frame.

The LDPC extra symbol segment, Pre-FEC padding factor and PE Disambiguity subfields in UHR-SIG common field of DL MU CoBF PPDU will be carried by the LDPC extra symbol segment, Pre-FEC padding factor and PE Disambiguity subfields in UHR variant Common Info field of the CoBF-trigger frame.

The IM subfield in UHR-SIG common field of DL MU CoBF PPDU is set to be “disabled” with value of “1”.

The Number of non-OFDMA users subfield in UHR-SIG common field of DL MU CoBF PPDU can be Determined from the number of user info fields in the CoBF-trigger frame. or it can be indicated by some reserved bits in the UHR variant Common Info or special User Info field of the CoBF trigger frame.

The STA-ID in the user field of UHR SIG in DL MU CoBF PPDU can be carried by the last 11 bit of the AID12 subfield in UHR variant User Info field of the CoBF trigger frame.

The MCS in the user field of UHR SIG in DL MU CoBF PPDU can be carried by the UL UHR-MCS subfield in UHR Variant User Info field of the CoBF trigger frame.

The Spatial Configuration in the user field of UHR SIG in DL MU CoBF PPDU can be carried by the SS Allocation subfield in UHR Variant User Info field of the CoBF trigger frame.

The BSS color differentiation in the user field of UHR SIG in DL MU CoBF PPDU, which is used to indicate which BSS the related STAID belongs to, will be carried by repurposed the UL FEC coding type subfield in UHR Variant User Info field of the CoBF trigger frame.

The 2×LDPC in the user field of UHR SIG in DL MU CoBF PPDU can be carried by the 2×LDPC subfield in UHR Variant User Info field of the Trigger frame.

TABLE 23
Trigger Frame Subfields and Corresponding
Subfield of UHR-SIG in UHR MU CoBF PPDU:

| | Subfield of UHR-SIG in | |
|---|---|---|
| Subfields in trigger frame | UHR MU CoBF PPDU | |
| | Comon | Spatial Reuse (set to be |
| | field | “PSR_AND_NON_SRG_{—} |
| | | OBSS_PD_PROHIBITED”) |
| GI And HE/UHR-LTF Type/TXS mode subfield in | | GI + LTF Size |
| UHR variant common Info field | | |
| Number of HE/UHR-LTF Symbols subfield in | | Number of UHR-LTF |
| UHR variant common Info field | | Symbols |
| LDPC Extra Symbol Segment subfield in UHR | | LDPC Extra Symbol |
| variant common Info field | | Segment |
| Pre-FEC padding Factor subfield in UHR variant | | Pre-FEC padding Factor |
| common Info field | | |
| PE Disambiguity subfield in UHR variant common | | PE Disambiguity |
| Info field | | |
| | | IM (Disabled) |
| | | Number of non-OFDMA |
| | | users(Determined from the |
| | | number of user info fields.) |
| AID12 in UHR variant User Info field (last 11 bits) | User field | STA-ID |
| UL UHR-MCS subfield in UHR Variant User Info | | MCS |
| field | | |
| SS Allocation subfield in UHR Variant User Info | | Spatial Configuration |
| field | | |
| Repurpose the UL FEC coding type subfield in | | BSS color differentiation |
| UHR Variant User Info field as the BSS color | | (or based on total number |
| differentiation bit | | of Users from two APs) |
| 2x LDPC subfield in UHR Variant User Info field | | 2x LDPC |

The CoBF-trigger frame may be a unicast frame with the shared AP's MAC address as the RA. It may be defined based on current basic or BSRP trigger frame with some minor change, or be defined as new trigger type, which will be indicated by one of the reserved values between 9-15. The trigger frame design can also be applied in the CoSR-trigger frame. To simplify the information sharing between two APs: fix T_{PE} for MU CoBF PPDU to be 20 μs, fix Pre-FEC padding Factor to be 4, fix LDPC Extra Symbol Segment to be 1.

Essential information to be carried in the CoBF/CoSR sync frame may include: GI and HE/UHR-LTF Type for DL MU CoBF PPDU, MAP type: 1-2 bits, CoBF/CoSR Invite/response/sync indication: 1-2 bits, BSS color 1: 6 bits, BA type if more than one BA type is defined for CoBF or CoSR: 1 bit, STA ID: 11 bits, Puncturing channel information: 5 bits, Number of CoBF users: 3 bits, TXOP: 7 bits, Max Target receiver power for sharing and shared AP in the DL SU CoSR transmission: 2×6 bits, RU Allocation (8 bits) with PS160 and number of OFDMA symbols (5 bits) for TB BA transmission if TB BA is used in response to the DL MU COBF/SU CoSR transmission, GI and HE/UHR-LTF type for TB BA in response to the DL MU COBF/SU CoSR if more than one value is defined for TB BA and TB BA is selected in response to the DL MU COBF/SU CoSR transmission. BSS color of the TB BA if TB BA is selected in response to the DL MU COBF/SU CoSR transmission. All of the above information can be carried by the corresponding similar field or by repurposing some fields or using reserved bits in the current trigger frame. Two designs are proposed in the present disclosure.

One proposal for the CoBF/CoSR syne frame is: Option 1: The trigger frame will include the UHR variant common info field, Special User info field, UHR User info field with AID as the identifier of the shared AP to carry some common information used in the U-SIG of the DL MU CoBF/SU COSR PPDU, then following with the UHR user info field with AID as the non-AP STA, which is the receiver of the DL MU CoBF PPDU if CoBF is enabled.

TABLE 24
UHR Variant Common Info Field Format:

| | | | | | | | |
|---|---|---|---|---|---|---|---|
| Field: | Trigger | L Length | More | CS | UL BW | GI and | Reserved |
| | Type | | TF | Required | | HE/URH- | |
| | | | | | | LTF Type | |
| Bits: | B0-B3 | B4-B15 | B16 | B17 | B18- | B20-B21 | B22 |
| | | | | | B19 | | |
| Field: | Number | Reserved | LDPC | AP Tx | Pre- | PE | UL |
| | of | | Extra | Power | FEC | Disambiguity | Spatial |
| | HE/UHR- | | Symbol | | Padding | | Reuse |
| | LTF | | Segment | | Factor | | |
| | Symbols | | | | | | |
| Bits: | B23-B25 | B26 | B27 | B28-B33 | B34- | B36 | B37-B52 |
| | | | | | B35 | | |
| Field: | Reserved | HE/UHR | Special | DRU/ | IFCS | UHR | Reserved |
| | | P160 | User | RRU | Present | Reserved | |
| | | | Info | Indication | Flag | | |
| | | | Field | | | | |
| | | | Flag | | | | |
| Bits: | B53 | B53 | B55 | B56-B59 | B60 | B61-B62 | B63 |

In the above example: B0-B3 (trigger type), BSRP trigger type may be reused for CoBF sync or CoBF invite frame, or be defined as a new trigger type. B4-B15, the UL Length field will be repurposed as the Length field in the L-SIG in the DL MU CoBF/SU COSR PPDU. B16, kept the same definition. B17, kept the same definition. B18-B19, UL BW will be with the UL Bandwidth Extension subfield in the special User Info field to jointly indicate the PPDU BW in U-SIG of the DL MU CoBF/SU COSR PPDU. B20-B21: The GI and HE/UHR-LTF Type/TXS mode will be used to indicate the GI and LTF size in the DL MU CoBF PPDU. If BSRP is reused or a new trigger type is used for CoBF or CoSR sync frames, the GI and HE/UHR-LTF type subfield encoding table may be as follows.

TABLE 25
GI and HE/UHR-LTF Type Subfield Encoding when BSRP is reused
or a new trigger type is used for CoBF/CoSR sync frame:

| GI And HE/UHR-LTF | |
|---|---|
| Type subfield value | Description |
| 0 | 2x HE/UHR-LTF + 0.8 μs GI |
| 1 | 2x HE/UHR-LTF + 1.6 μs GI |
| 2 | 4x HE/UHR-LTF + 3.2 μs GI |
| 3 | BSRP Trigger soliciting an M-BA in |
| | non-HT (dup) PPDU or reserved |

If a new trigger type is used for CoBF or CoSR sync frames, the GI and HE/UHR-LTF Type subfield encoding table may be as one of the options in Table 26 or Table 27.

TABLE 26
GI and HE/UHR-LTF Type Subfield Encoding when a new trigger
type is used for CoBF/CoSR sync frame (Option 1):

| GI And HE/UHR-LTF | |
|---|---|
| Type subfield value | Description |
| 0 | 1x HE/UHR-LTF + 1.6 μs GI |
| 1 | 2x HE/UHR-LTF + 1.6 μs GI |
| 2 | 4x HE/UHR-LTF + 3.2 μs GI |
| 3 | 2x HE/UHR-LTF + 0.8 μs GI |

TABLE 27
GI and HE/UHR-LTF Type Subfield Encoding when a new trigger
type is used for CoBF/CoSR sync frame (Option 2):

| GI And HE/UHR-LTF | |
|---|---|
| Type subfield value | Description |
| 0 | 2x HE/UHR-LTF + 0.8 μs GI |
| 1 | 2x HE/UHR-LTF + 1.6 μs GI |
| 2 | 4x HE/UHR-LTF + 0.8 μs GI |
| 3 | 4x HE/UHR-LTF + 3.2 μs GI |

The GI and HE/UHR-LTF Type/TXS mode may be used to indicate the GI and LTF size in the TB BA which is the response to the DL MU CoBF/SU COSR PPDU if TB BA is used for the DL MU CoBF/SU COSR PPDU transmission.

If BSRP trigger type with GI and HE/UHR-LTF field in the common field equal to 3 is used to indicate a CoBY/CoSR sync frame, the GI and UHR-LTF Type for DL MU CoBF transmission may be indicated by another two reserved bits in the UHR common info, special User info, or UHR variant user info with AID as the identifier of the sharing AP, or even the reserved bits in the UHR variant user info field as one of the following two options in Tables 28 and 29:

TABLE 28
Option 1 for Signaling GI and UHR-
LTF Type for DL MU CoBF transmission:

| GI And UHR-LTF | |
|---|---|
| Type subfield value | |
| for DL MU CoBF | |
| PPDU | Description |
| 0 | 2x HE/UHR-LTF + 0.8 μs GI |
| 1 | 2x HE/UHR-LTF + 1.6 μs GI |
| 2 | 4x HE/UHR-LTF + 3.2 μs GI |
| 3 | Reserved |

TABLE 29
Option 2 for Signaling GI and UHR-
LTF Type for DL MU CoBF transmission:

| GI And HE/UHR-LTF | |
|---|---|
| Type subfield value | Description |
| 0 | 2x HE/UHR-LTF + 0.8 μs GI |
| 1 | 2x HE/UHR-LTF + 1.6 μs GI |
| 2 | 4x HE/UHR-LTF + 0.8 μs GI |
| 3 | 4x HE/UHR-LTF + 3.2 μs GI |

For the above options: B22: kept the same or used to indicate it is CoBF or CoSR sync frame. B23-B25: it will be used to indicate the number of UHR-LTF symbols in the DL MU CoBF PPDU or also the number of UHR-LTF symbols in the DL SU CoSR PPDU if needed. B26: kept the same definition. B27: kept the same, or kept the same subfield but fixed it to be 1 for CoBF sync frame or may be repurposed for other indication or be as reserved bit if it is fixed to 1. B28-B33: AP tx Power for the sharing AP or for the shared AP TX power or repurposed for other indication or be as reserved bits. B34-B35: kept the same, or kept the same subfield but fixed to be 4 in CoBF sync frame, or may be repurposed for other indication or be as reserved bits if it is fixed to 4 in CoBF sync frame. B36: kept the same definition. B37-B52: kept the same to keep backward compatibility or maybe repurposed for other functions indication or be as reserved bits if it is fixed to be disabled or a new trigger type is used for the CoBF or CoSR sync frame. B53: kept the same definition. B54: kept the same definition. B55: kept the same definition. B56-B59: DRU/RRU indication. B60: IFCS present indication. B61-B62: UHR reserved. B63: reserved.

An example special user info field is shown below in Table 30.

TABLE 30
Special User Info Field:

| Field: | AID 12 | PHY | UL BW | EHT/UHR | EHT/UHR | U-SIG Disregard and Validate | | |
|---|---|---|---|---|---|---|---|---|
| | (2007) | Version | Extension | Spatial | Spatial | Map to | Map to | Map to |
| | | ID | | Reuse 1 | Reuse 2 | B20-B25 | B2 in | B11- |
| | | | | | | in U- | U-SIG2 | B15 in |
| | | | | | | SIG1 | | U-SIG2 |
| | | | | MAP | BSS Color 1 | Disregard/ | Validate | Number |
| | | | | Type | (6) | Validate | bit set | of |
| | | | | (2)(CoBF) | | | to 1 | UHR- |
| | | | | | | | | SIG |
| | | | | | | | | symbols |
| | | | | | | BSS | CoBF/ | Number |
| | | | | | | Color 2 | CoSR | of |
| | | | | | | | bit set | UHR- |
| | | | | | | | to 0 | SIG |
| | | | | | | | | symbols |

| | | | | | | |
|---|---|---|---|---|---|---|
| Bits: | B0-B11 | B12-B14 | B15-B16 | B17-B20 | B21-B24 | B25-B36 |

| Field: | Reserved | | Trigger Dependent User Info |
|---|---|---|---|
| | BA Type | Reserved | |

| | | | |
|---|---|---|---|
| Bits: | B37 | B38-B39 | Variable |

For the special user info field above: AID as 2007, PHY version identifier: 1. UL Bandwidth extension will be with the UL BW subfield in the UHR variance common info field to jointly indicate the PPDU BW in U-SIG of the DL MU CoBF PPDU. EHT/UHR spatial reuse 1/2: Option 1: kept the same subfield. Option 2: kept the same subfield and may be used to carry the Spatial Reuse 1/2 value in U-SIG field of the TB-BA in response to the DL MU CoBF/SU CoSR PPDU. Option 3: maybe repurposed for other indication or as reserved bits if it is fixed to be disabled of DL MU CoBF/SU COSR PPDU transmission. One example design: repurpose spatial reuse 1 and spatial reuse 2 as MAP type and BSS color 1 in DL MU CoBF/CoSR PPDU. Two bits may be used to indicate the MAP type: CoBF, CoSR type I mode or CoSR type 2 mode. Six bits may be used to indicate the first BSS color in the U-SIG of DL MU CoBF/SU COSR PPDU. U-SIG Disregard and Validate: extend the mapping table for TB PPDU case only to also for the MU CoBF/SU COSR PPDU case. B0-B5: BSS color of the shared AP which will be indicated in the B20-B25 in the U-SIG1 of the DL MU CoBF/SU COSR PPDU. B6: CoBF/CoSR indication, which will be indicated in the B2 in the U-SIG2 of the DL MU CoBF/SU COSR PPDU. B7-B11: Number of UHR-SIG symbols, which will be indicated in the B11-B15 in the U-SIG2 of the DL MU CoBF/SU COSR PPDU. B37-B39: reserved or maybe used to indicate whether it is CoBF or CoSR type1 or type 2; or whether it is CoBF/CoSR invite, response or sync, or sync follower/reference; or the BA type (OFDMA mode, TDMA mode). Note: BA Type field will be a reserved field if a single BA type is defined for DL MU CoBF or SU CoSR PPDU.

For UHR Variant User Info with AID as the identifier of the shared AP to carry some common information that used in the U-SIG of the following DL MU CoBF/SU COSR PPDU. B0-B11 (STA ID): the AID of the shared AP assigned by the sharing AP. B12-B19 (RU Allocation): the assigned total RU/MRU for the BA of all the STAs associated with the shared AP in response to the DL MU CoBF/SU COSR PPDU if TB OFDMA mode BA is selected and indicated by a reserved bit in the common or special user info field, otherwise, it will be kept as RU allocation or be reserved bits. B20: kept the same as FEC coding type indication or be repurposed as BSS color indication bit or be repurposed as the GI and UHR-LTF type with two values for the TB-BA in response to the DL MU CoBF/SU COSR PPDU if TB BA is selected and indicated to be used or sync follower or reference indication. B21-B25 (puncturing channel information): puncturing channel information, such as the static puncturing channel information of the sharing AP. B26-B31 (Max TX power of shared AP or reserved bits): Max TX power of the shared AP if MAP CoSR type is indicated, or the first BSS color in the U-SIG of DL MU CoBF/SU COSR PPDU if it is not indicated in the special user info field, or be reserved bits. B32-B38 (TXOP or number of OFDM symbols for TB BA (5 bits) and number of UHR-LTF symbols for TB BA (2 bits)): TXOP for the DL MU CoBF/SU COSR PPDU if TXOP is needed for NAV setting and TDMA mode-based BA is selected and indicated as the BA type, or number of OFDM symbols for TB BA (5 bits) and number of UHR-LTF symbols for TB BA (2 bits) if TB-based BA is selected and indicated as the BA type, otherwise, it will be reserved bits. B39 (P160): kept the same as PS160 subfield if TB-based BA is selected and indicated as the BA type, otherwise, it will be kept the same as PS160 or become as a reserved bit.

For UHR Variant User Info with AID as the receiver of the following DL MU CoBF PPDU to carry the per user info field information with current UHR variant user info field format if CoBF Multi-AP Type is indicated.

TABLE 31
UHR Variant User Info with AID as the receiver:

| | | | | | | | |
|---|---|---|---|---|---|---|---|
| B0-B11 | B12-B19 | B20 | B21- | B26 | B27- | B32-B38 | B39 |
| | | | B25 | | B31 | | |
| BSS 1 | RU | BSS | UL | 2x | SS | Reserved | PS160 |
| STA | Allocation | color | UHR- | LDPC | Allo- | | (reserved) |
| ID(11) | (reserved) | Diff? | MCS | | cation | | |
| BSS 2 | RU | BSS | UL | 2x | SS | Reserved | PS160 |
| STA | Allocation | color | UHR- | LDPC | Allo- | | (reserved) |
| ID(11) | (reserved) | Diff? | MCS | | cation | | |

For the UHR Variant User Info field above: B0-B11: AID12: First or last 11 bit as the STA ID of the non-AP STA,B12-B19: kept it as RU allocation or reserved, B20: kept the same as FEC coding type indication or be repurposed as BSS color indication bit or reserved bit, B21-B25: UHR-MCS for corresponding STA in the DL MU CoBF PPDU, B26: 2×LDPC for corresponding STA in the DL MU CoBF PPDU, B27-B31: SS Allocation for corresponding STA in the DL MU CoBF PPDU, B32-B38: kept it as UL Target Receiver power or reserved bits, PS160: kept it as P160 or be a reserved bit.

Table 32 below is an example design of the UHR Variant User Info Field list for a first case of multiple cases.

TABLE 32
Case 1 of UHR Variant User Info field (may be 1-2 user info in BSS1
and BSS2):

| | | | | | | | |
|---|---|---|---|---|---|---|---|
| B0-B11 | B12-B19 | B20 | B21-B25 | B26 | B27-B31 | B32-B38 | B39 |
| STA ID | RU | BSS | Puncturing | Reserved | | TXOP | PS160 |
| (11) | Allocation | color | channel | | | | (reserved) |
| identifier | (reserved) | Diff? | information | | | | |
| of AP2 | | | | | | | |
| BSS 1 | RU | BSS | UL UHR- | 2x | SS | Reserved | PS160 |
| STA ID | Allocation | color | MCS | LDPC | Allocation | | (reserved) |
| (11) | (reserved) | Diff? | | | | | |
| BSS 2 | RU | BSS | UL UHR- | 2x | SS | Reserved | PS160 |
| STA | Allocation | color | MCS | LDPC | Allocation | | (reserved) |
| ID(11) | (reserved) | Diff? | | | | | |

Case 2: UHR variant user Info field list when it is for CoBF sync frame with TB-BA is used:

TABLE 33
Case 2 of UHR Variant User Info field (may be 1-2 user info in BSS1
and BSS2):

| B0-B11 | B12-B19 | B20 | B21-B25 | B26 | B27-B31 | B32-B38 | B39 |
|---|---|---|---|---|---|---|---|
| STA | RU | Reserved | Puncturing | Reserved | | Number | PS160 |
| ID(11) | Allocation | | channel | | | of OFDM | |
| of AP2 | | | information | | | symbols | |
| | | | | | | for TB | |
| | | | | | | BA(5) + | |
| | | | | | | number | |
| | | | | | | of UHR- | |
| | | | | | | LTF | |
| | | | | | | symbols | |
| | | | | | | for TB | |
| | | | | | | BA | |
| BSS 1 | RU | BSS | UL UHR- | 2x | SS | Reserved | PS160 |
| STA | Allocation | color | MCS | LDPC | Allocation | | (reserved) |
| ID(11) | (reserved) | Diff? | | | | | |
| BSS 2 | RU | BSS | UL UHR- | 2x | SS | Reserved | PS160 |
| STA | Allocation | color | MCS | LDPC | Allocation | | (reserved) |
| ID(11) | (reserved) | Diff? | | | | | |

Case 3: UHR variant user Info field list when it is for CoSR sync frame with TDMA-BA is used:

TABLE 34
Case 3 of UHR Variant User Info field:

| | | | | | | | |
|---|---|---|---|---|---|---|---|
| B0-B11 | B12-B19 | B20 | B21-B25 | B26 | B27- | B32- | B39 |
| | | | | | B31 | B38 | |
| STA | RU | Reserved | Puncturing | Max. TX | | TXOP | PS160(reserved) |
| ID(11) | Allocation | | channel | power of | | | |
| identifier | (reserved) | | information | shared AP | | | |
| of AP2 | | | | | | | |

Case 4: UHR variant user Info field list when it is for CoSR sync frame with TB-BA is used:

TABLE 35
Case 4 of UHR Variant User Info field:

| | | | | | | | |
|---|---|---|---|---|---|---|---|
| B0-B11 | B12-B19 | B20 | B21-B25 | B26 | B27- | B32-B38 | B39 |
| | | | | | B31 | | |
| STA | RU | Reserved | Puncturing | Max. TX | | Number of | PS160 |
| ID(11) | Allocation | | channel | power of | | OFDM | |
| identifier | | | information | shared AP | | symbols for TB | |
| of AP2 | | | | | | BA(5) + number | |
| | | | | | | of UHR-LTF | |
| | | | | | | symbols for TB | |
| | | | | | | BA | |

Option 2: The trigger frame may include the UHR variant common info field, Special User info field, UHR User info field with AID as the sharing AP if it is CoSR sync frame or non-AP STAs (the receiver of the DL MU CoBF PPDU) if it is CoBF sync frame: UHR variant common info field: same as that in option 1. Special User info field: same as that in option 1. UHR Variant User Info field for the non-AP STAs if it is indicated as CoBF sync frame. Note: there may be 1-2 User info in BSS1 and BSS2:

TABLE 36
UHR Variant User Info Field for Non-AP STAs if Indicated as
CoBF Sync frame:

| | | | | | | | |
|---|---|---|---|---|---|---|---|
| B0- | B12-B19 | B20 | B21- | B26 | B27- | B32-B38 | B39 |
| B11 | | | B25 | | B31 | | |
| BSS 1 | Puncturing | BSS | UL | 2x | SS | TXOP | reserved |
| STA | channel + | color | UHR- | LDPC | Allo- | (Re- | |
| ID(11) | number | Diff? | MCS | | cation | served) | |
| | of CoBF | | | | | | |
| | users | | | | | | |
| BSS 2 | RU | BSS | UL | 2x | SS | Number | PS160 |
| STA | Allocation | color | UHR- | LDPC | Allo- | of | (re- |
| ID(11) | (reserved) | Diff? | MCS | | cation | OFDM | served) |
| | | | | | | symbols | |
| | | | | | | for TB | |
| | | | | | | BA(5) + | |
| | | | | | | number | |
| | | | | | | of | |
| | | | | | | UHR- | |
| | | | | | | LTF | |
| | | | | | | symbols | |
| | | | | | | for | |
| | | | | | | TB BA | |
| | | | | | | (Re- | |
| | | | | | | served) | |

For the above option: B0-B11: AID12: First or last 11 bit as the STA ID of the non-AP STA. B12-B19: If the AID is for the STA associated with BSS 1, these 8 bits will be used to indicate the number of CoBF users in the DL MU COBF PPDU (3 bits) and the puncturing channel information of the DL MU COBF PPDU (5 bits). If the AID is for the STA associated with BSS 2, these 8 bits will be kept as RU Allocation combined together with PS160 to indicate the assigned RU/MRU for the TB BA of this STA or the assigned total RU/MRU for the TB BA of all the STAs associated with the shared AP in response to the DL MU CoBF PPDU if TB OFDMA mode BA is selected and indicated by a reserved bit in the common or special user info field, otherwise, it will be kept as RU allocation or be reserved bits. B20: kept the same as FEC coding type indication or be repurposed as BSS color indication bit (which BSS the STA with the STA ID is belongs to) or reserved bit. B21-B25: UHR-MCS for corresponding STA in the DL MU CoBF PPDU. B26: 2×LDPC for corresponding STA in the DL MU CoBF PPDU. B27-B31: SS Allocation for corresponding STA in the DL MU CoBF PPDU. B32-B38: If the AID is for the STA associated with BSS 1, these 7 bits will be used to indicate the TXOP if it is indicated as CoBF sync frame with TDMA based BA type is used and this information is needed for NAV setting, otherwise, it will be kept as UL Target receiver power or be reserved bits.

If the AID is for the STA associated with BSS 2, these 7 bits will be used to indicate 5-bit number of OFDM Symbols and 2-bit the number of UHR-LTF symbols for the BA in response to the DL MU CoBF PPDU if OFDMA mode BA is selected and indicated by a reserved bit in the common or special user info field, otherwise, it will be kept as UL Target receiver power or be reserved bits.

PS160: If the AID is for the STA associated with BSS 1, kept it as P160 or as the GI and UHR-LTF type with two values for the TB-BA in response to the DL MU CoBF/SU CoBF PPDU is TB BA is selected and indicated to be used or be a reserved bit. If the AID is for the STA associated with BSS 2, it will be combined together with the RU Allocation to indicate the assigned RU/MRU for the BA of this STA or the assigned total RU/MRU for the BA of all the STAs associated with the shared AP in response to the DL MU CoBF PPDU if OFDMA mode BA is selected and indicated by a reserved bit in the common or special user info field, otherwise, it will be kept as PS160 or be a reserved bit.

For a UHR Variant User Info field with AID as identifier of the shared AP if it is indicated as CoSR sync frame: B0-B11: AID12: First or last 11 bit as the identifier of the shared AP. B12: B19: RU Allocation will be combined together with the PS160 to indicate the assigned RU/MRU for the BA of all the STAs associated with the shared AP in response to the DL SU COSR PPDU if OFDMA mode BA is selected and indicated by a reserved bit in the common or special user info field, otherwise, it will be kept as RU allocation or be reserved bits. B20: kept the same as FEC coding type indication or as the GI and UHR-LTF type with two values for the TB-BA in response to the DL MU CoBF/SU COSR PPDU if TB BA is selected and indicated to be used or be a reserved bit. B21-B25: puncturing channel information, such as the static puncturing channel information of the sharing AP. B26-B31: Max TX power of shared AP, or be reserved bits. B32-B38: these 7 bits will be used to indicate the TXOP if it is indicated as CoSR sync frame with TDMA based BA type is used and this information is needed for NAV setting, otherwise it will be used to indicate 5-bit number of OFDM Symbols and 2-bit the number of UHR-LTF symbols for the BA in response to the DL SU COSR PPDU if OFDMA mode TB BA is selected and indicated by a reserved bit in the common or special user info field, otherwise, it will be kept as UL Tx target received Power field or be reserved bits. B39, it will be kept as PS160 combined with the RU Allocation subfield to indicate the assigned RU for the BA in response to the DL MU CoSR PPDU if OFDMA mode BA is selected and indicated by a reserved bit in the common or special user info field.

For TB-BA in response to the DL MU CoBF or DL SU CoSR transmission, the BSS color of the TB BA may be set to 0, or the BSS color of the sharing AP, or the BSS color of their own AP if the BA from two BSSs are assigned with RU over different 80 MHz subchannel, or with two BSS colors in the U-SIG of the TB-PPDU.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

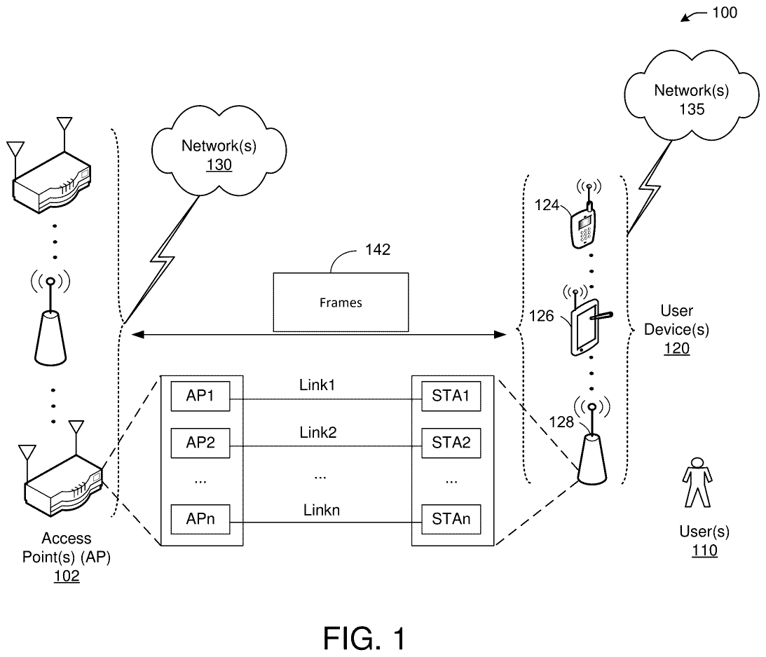

FIG. 1 is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

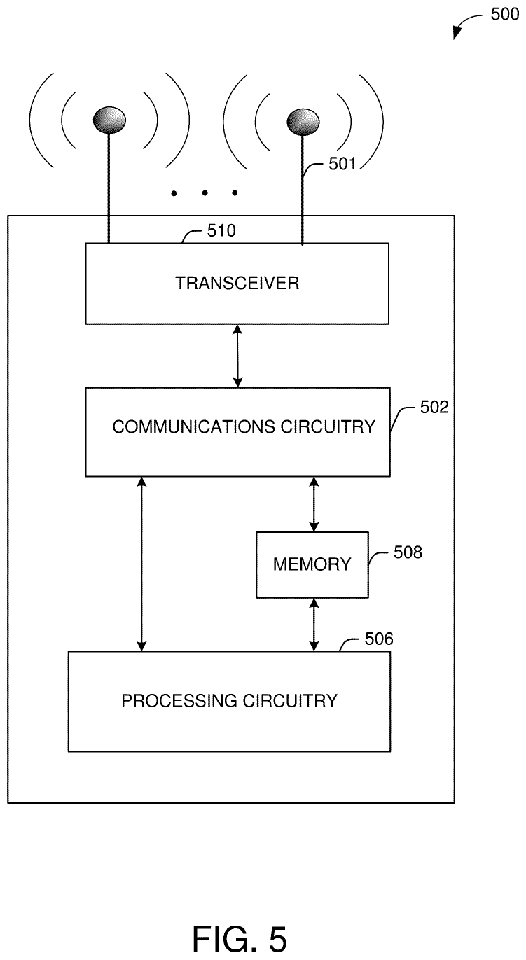

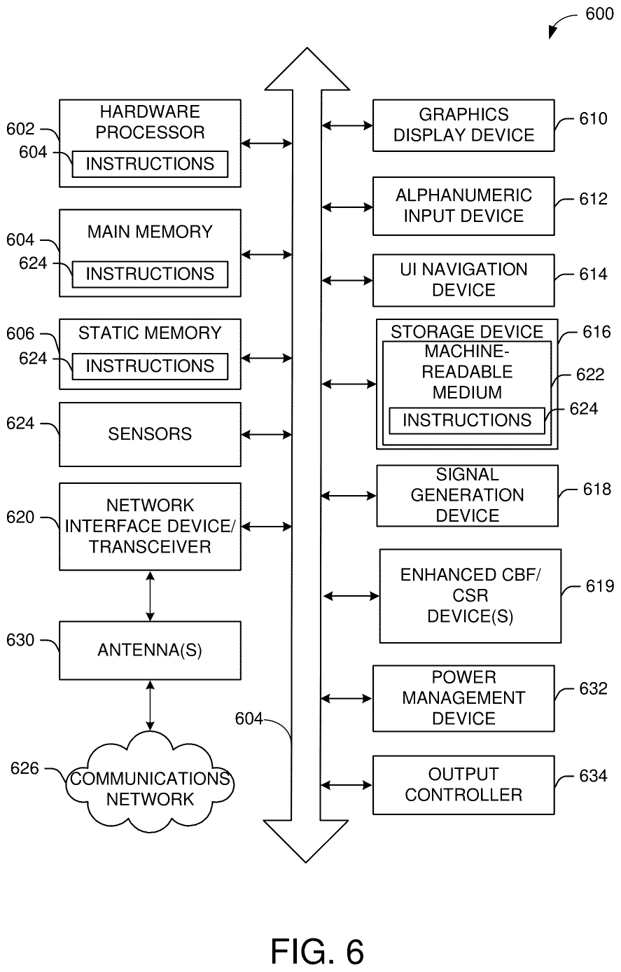

In some embodiments, the user devices 120 and the AP 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IOT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IOT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11 g, 802.11n, 802.11ax), 5 GHz channels (e.g. 802.11n, 802.11ac, 802.11ax, 802.11be, 802.11bn, etc.), 6 GHZ channels (e.g., 802.11ax, 802.11be, 802.11bn, etc.), 60 GHZ channels (e.g. 802.11ad, 802.11ay), or 42 GHz-71 GHz channels (802.11bq). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may exchange frames 142 with one or more user devices 120. The frames 142 may include CBF signaling and frames, CSR signaling and frames, and other frames as defined herein.

The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs.

It is understood that the above descriptions are for the purposes of illustration and are not meant to be limiting.

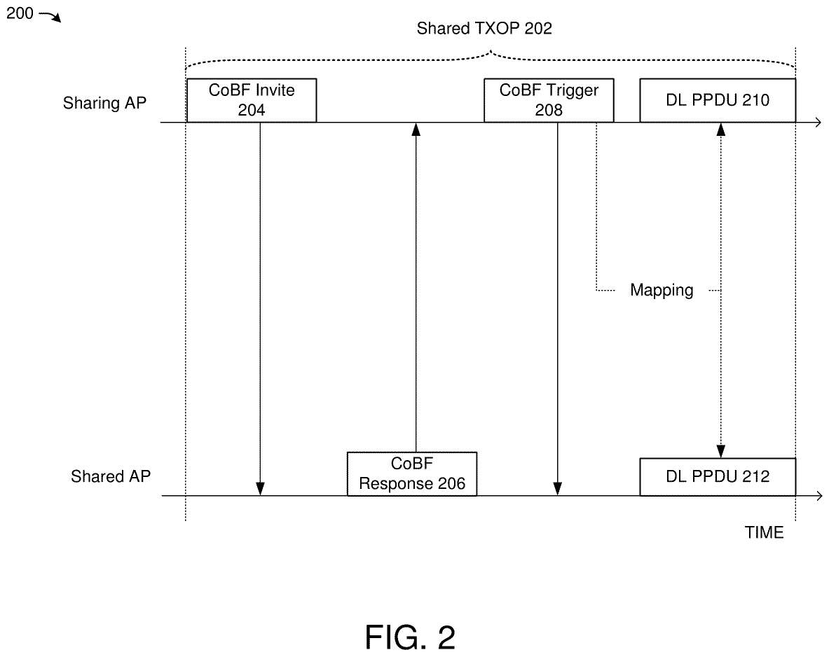

FIG. 2 shows an example sequence 200 for a downlink multi-user CoBF transmission, in accordance with one or more embodiments of the present disclosure.

Referring to FIG. 2, during a shared TXOP 202 between a sharing AP and a shared AP, the sharing AP may send a CoBF invite 204, to which the shared AP may send a CoBF response 206. The sharing AP may send a CoBF trigger frame 208 to trigger simultaneous transmissions of the sharing AP and the shared AP (e.g., DL PPDU 210 and DL PPDU 212).

In the example sequence 700 for DL MU CoBF transmission, there may be multiple main handshakes/steps. In a first step, the sharing AP may send the CoBF invite frame 204 to the shared AP with the CoBF invitation request, including the candidate or participating CoBF STA information, such as STA-ID, buffer status, number of assigned spatial streams, length, etc. In a second step, the shared AP may, based on the information shared by the sharing AP to select the candidate or participating CoBF STA with the related transmission parameters, then respond to the CoBF invitation request with confirmation (the CoBF response 206) and the candidate or participating CoBF STA information including the STA-ID, MCS, whether 2×LDPC is used or not, LDPC extra symbol segment, LDPC pre-FEC padding factor and PE Disambiguity based on Length information with the data rate, number of spatial streams and etc. In a third step, the sharing AP will analyze all the collected information and determine the final transmission parameters for the DL MU CoBF transmission, which will include: (1) Length field in the L-SIG of the DL MU PPDU, (2) Fields in the U-SIG of the DL MU PPDU as shown in Table 17 above.

The trigger frame 208 may be mapped to the L-SIG, U-SIG, and UHR-SIG fields of the DL PPDUs. The DL PPDUs may be synchronized and the data prepared for transmission.

Table 18 above shows a UHR-SIG format defined for DL MU-PPDU transmission in 802.11bn v0.1.

After that, the sharing AP may carry all the determined parameters for DL MU CoBF data transmission in the CoBF-sync frame following the current defined trigger frame format in 802.11bn v0.1, which includes the UHR variant Common Info field, Special User Info field and the UHR variant User Info field as defined above in Table 19.

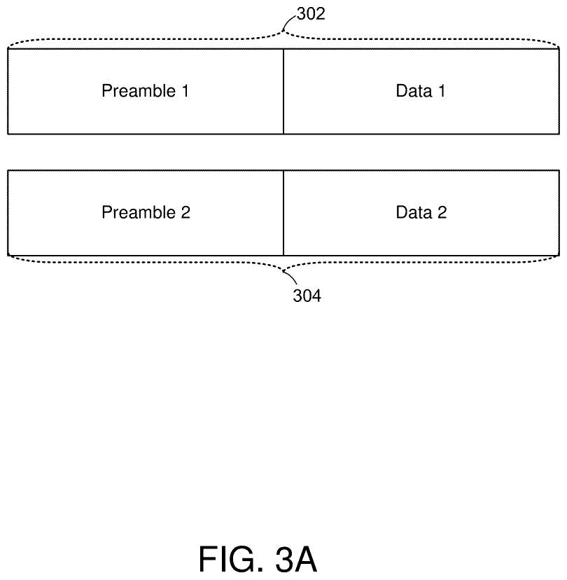

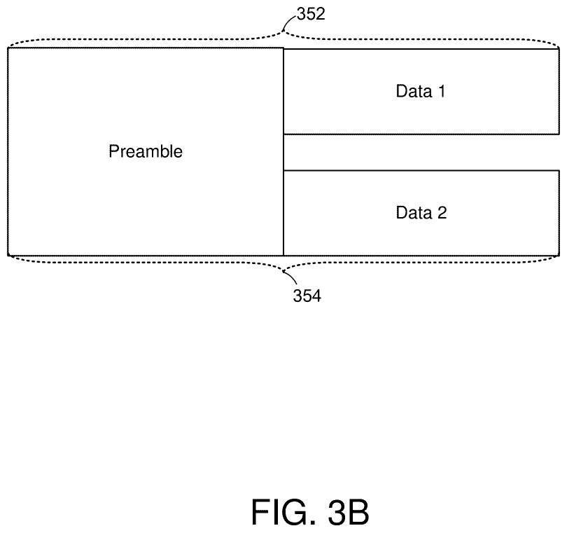

FIG. 3A shows example OFDMA transmissions acknowledging CBF data frames, in accordance with one or more example embodiments of the present disclosure.

Referring to FIG. 3A, a first uplink OFDMA acknowledgment 302 may be sent in response to a CBF data frame (e.g., one of the user devices 120 of FIG. 1 may receive the DL PPDU 210 of FIG. 2 as a CBF data frame, and may respond with the first uplink OFDMA acknowledgment 302), and a second uplink OFDMA acknowledgment 304 may be sent in response to another CBF data frame (e.g., one of the user devices 120 of FIG. 1 may receive the DL PPDU 212 of FIG. 2 as a CBF data frame, and may respond with the second uplink OFDMA acknowledgment 304). The first uplink OFDMA acknowledgment 302 and the second uplink OFDMA acknowledgment 304 both may include a preamble followed by data.

For the acknowledgement of the CBF data frames, the sharing AP may allocate frequency resources to the shared AP in the trigger (or synch) frame. The Ack or Block Ack (BA) may be sent in uplink OFDMA mode by the STA. The OFDMA resource allocation may be indicated in the trigger/synch frame right before the CBF Data transmission. The resource allocation, e.g., the bandwidth or RU allocation, may be indicated in the RU allocation subfield of the user info field of the trigger frame. The sharing AP may allocate the RU allocation for the scheduled STAs of both sharing AP and shared AP. There are two options for the OFDMA transmission as illustrated in FIGS. 3A and 3B.

In Option (a) in FIG. 3A, both the preamble and the associated data OFDM symbols are within a portion of the band, e.g., a subchannel or resource unit (RU). The preambles of different STAs can be different. For example, the BSS color in Preamble 1 may be set by a STA of sharing AP to the BSS color of the sharing AP and the BSS color in Preamble 2 may be set by a STA of the shared AP to the BSS color of the shared AP.

FIG. 3B shows example OFDMA transmissions acknowledging CBF data frames, in accordance with one or more example embodiments of the present disclosure.

Referring to FIG. 3B, a first uplink OFDMA acknowledgment 352 may be sent in response to a CBF data frame (e.g., one of the user devices 120 of FIG. 1 may receive the DL PPDU 210 of FIG. 2 as a CBF data frame, and may respond with the first uplink OFDMA acknowledgment 352), and a second uplink OFDMA acknowledgment 354 may be sent in response to another CBF data frame (e.g., one of the user devices 120 of FIG. 1 may receive the DL PPDU 212 of FIG. 2 as a CBF data frame, and may respond with the second uplink OFDMA acknowledgment 354).

In Option (b) in FIG. 3B, the preamble is of full bandwidth and the data OFDM symbols of different STAs are sent in different portions of the band, e.g., different subchannels or RUs. Because the preamble signal of each STA is the same, the BSS color in the preamble may be set to the BSS color of the sharing AP (or the shared AP). Option (b) in FIG. 3A provides a higher granularity of RU allocation than Option (a) in FIG. 3A. For example, a 60 MHz channel is shared by two APs.

In Option (a) in FIG. 3A, one AP may get 40 MHz and the other may get 20 MHz. In Option (b) in FIG. 3B, there are four 106-tone-RUs in 60 MHz. Each AP can get three 106-tone-RUs. Namely, the frequency resource can be divided more evenly among the APs for the Ack or BA uplink transmissions. Because the Ack or BA transmission duration is the same for all the CBF STAs, the finer RU granularity the evener resource allocation and the less the resource is wasted. Besides the BSS color setting, other parameters in the uplink PPDU preamble may be specified by the sharing AP in the trigger frame as well, e.g., the Length field in the L-SIG. The duration of the uplink transmission needs to be specified or derived from some parameter(s) in the CBF trigger/synch frame.

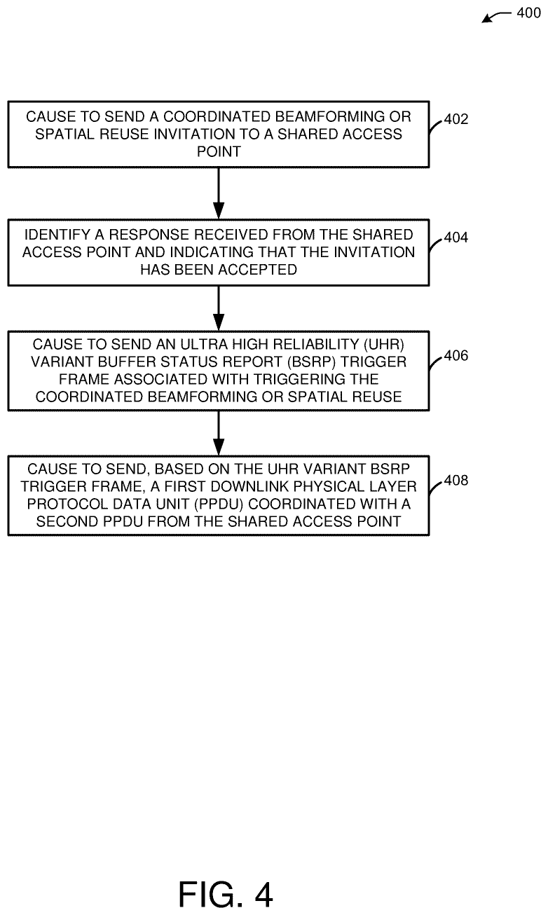

FIG. 4 illustrates a flow diagram of illustrative process 400 for CoBF and CoSR, in accordance with one or more example embodiments of the present disclosure.

At block 402, a device (e.g., the AP 102 of FIG. 1, the sharing AP of FIG. 2, and/or the enhanced CBF/CSR device 619 of FIG. 6) may cause to send a CBF or CoSR invite frame (e.g., the CBF invite 204 of FIG. 2), which may include the candidate or participating STA information, such as STA-ID, buffer status, number of assigned spatial streams, length, etc.

At block 404, the device may identify a response received from another AP (e.g., the shared AP of FIG. 2) and indicating that the invitation has been accepted. The shared AP may, based on the information shared by the sharing AP to select the candidate or participating STA with the related transmission parameters, respond to the invitation request with confirmation (the CoBF response 206) and the candidate or participating STA information including the STA-ID, MCS, whether 2×LDPC is used or not, LDPC extra symbol segment, LDPC pre-FEC padding factor and PE Disambiguity based on Length information with the data rate, number of spatial streams and etc. In a third step, the sharing AP will analyze all the collected information and determine the final transmission parameters for the DL MU CoBF transmission, which will include: (1) Length field in the L-SIG of the DL MU PPDU, (2) Fields in the U-SIG of the DL MU PPDU as shown in Table 17 above.

At block 406, the device may cause to send a UHR variant BSRP trigger frame (e.g., the CoBF trigger frame 208) associated with triggering CoBF or CoSR for simultaneous downlink transmission with the other AP. The CoBF invitation frame may signal that the trigger frame is a UHR BSRP variant. The CoBF trigger frame may include a special user info flag field in the common info field set to 0 to indicate that the special user info field is present in the trigger frame. The special user info field may be flowed by multiple user info fields, and the common info field of the trigger frame may include a trigger type subfield, a length subfield, a more TF subfield, a CS required subfield, a UL BW subfield, a GI and UHR-LTF type subfield, a reserved bit, a number of UHR-LTF symbols subfield, a reserved bit, an LDPC extra symbol segment subfield, an AP TX power subfield, a pre-FEC padding factor subfield, a PE disambiguity subfield, a UL spatial reuse subfield, a reserved bit, a UHR P160 subfield, a special user info field flag, reserved bits, an IFCS absent flag, an MAPC trigger type subfield, and a reserved bit. The Length field indicates the value to be set in the Length field in the L-SIG field of the MU PPDU transmitted by the Co-BF coordinating AP in the Co-BF transmission, and also indicates the value to be set in the Length field in the L-SIG field of the MU PPDU transmitted by the Co-BF coordinated AP in the Co-BF transmission. The More TF field indicates whether or not a subsequent Co-BF Trigger frame is scheduled for transmission. The More TF field is set to 1 if the Co-BF coordinating AP intends to schedule a subsequent Co-BF Trigger frame is the current TXOP, and is set to 0 otherwise. The GI And UHR-LTF Type field indicates the GI and the LTF size of the MU PPDU of the Co-BF transmission. The GI And UHR-LTF Type field is set to 0 to indicate 2×LTF+0.8 μs GI, is set to 1 to indicate 2×LTF+1.6 μs GI, and is set to 2 to indicate 4×LTF+3.2 μs GI. The Number Of UHR-LTF Symbols field indicates the number of UHR-LTF symbols of the MU PPDU of the Co-BF transmission, see 9.3.1.22.2 (Common Info field). The MAPC Trigger Type field indicates the MAPC Trigger type of the BSRP Trigger frame, with the encoding defined in Table 9-xx (MAPC Trigger Type field encoding).

At block 408, the device may cause to send a first DL PPDU (e.g., DL PPDU 210) at a same time as a second DL PPDU from the other device (e.g., the DL PPDU 212) based on the synchronization and mapping from the trigger frame.

It is understood that the above descriptions are for the purposes of illustration and are not meant to be limiting.

FIG. 5 shows a functional diagram of an exemplary communication station 300, in accordance with one or more example embodiments of the present disclosure. In one embodiment, FIG. 5 illustrates a functional block diagram of a communication station that may be suitable for use as an AP 102 (FIG. 1) or a user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an enhanced CBF/CSR device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 602 for generation and processing of the baseband signals and for controlling operations of the main memory 604, the storage device 616, and/or the enhanced CBF/CSR device 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced CBF/CSR device 619 may carry out or perform any of the operations and processes (e.g., process 400) described and shown above.

It is understood that the above are only a subset of what the enhanced CBF/CSR device 619 may be configured to perform and that other functions included throughout this disclosure may also be performed by the enhanced CBF/CSR device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

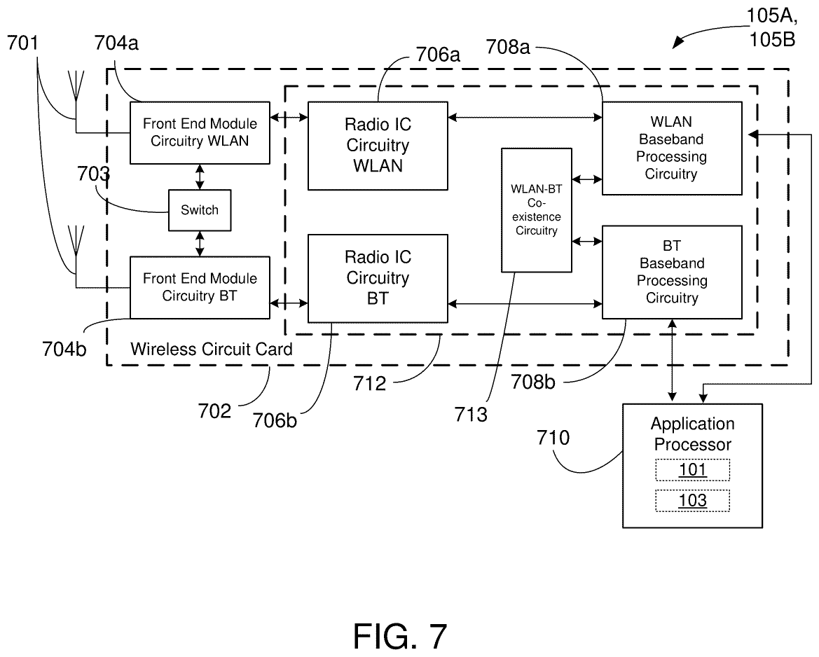

FIG. 7 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 704a-b, radio IC circuitry 706a-b and baseband processing circuitry 708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably. FEM circuitry 704a-b may include a WLAN or Wi-Fi FEM circuitry 704a and a Bluetooth (BT) FEM circuitry 704b.

The WLAN FEM circuitry 704a may include a receive signal path comprising circuitry configured to operate on WLAN RF signals received from one or more antennas 701, to amplify the received signals and to provide the amplified versions of the received signals to the WLAN radio IC circuitry 706a for further processing. The BT FEM circuitry 704b may include a receive signal path which may include circuitry configured to operate on BT RF signals received from one or more antennas 701, to amplify the received signals and to provide the amplified versions of the received signals to the BT radio IC circuitry 706b for further processing. FEM circuitry 704a may also include a transmit signal path which may include circuitry configured to amplify WLAN signals provided by the radio IC circuitry 706a for wireless transmission by one or more of the antennas 701. In addition, FEM circuitry 704b may also include a transmit signal path which may include circuitry configured to amplify BT signals provided by the radio IC circuitry 706b for wireless transmission by the one or more antennas.

In the embodiment of FIG. 7, although FEM 704a and FEM 704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals. Radio IC circuitry 706a-b as shown may include WLAN radio IC circuitry 706a and BT radio IC circuitry 706b. The WLAN radio IC circuitry 706a may include a receive signal path which may include circuitry to down-convert WLAN RF signals received from the FEM circuitry 704a and provide baseband signals to WLAN baseband processing circuitry 708a. BT radio IC circuitry 706b may in turn include a receive signal path which may include circuitry to down-convert BT RF signals received from the FEM circuitry 704b and provide baseband signals to BT baseband processing circuitry 708b.

WLAN radio IC circuitry 706a may also include a transmit signal path which may include circuitry to up-convert WLAN baseband signals provided by the WLAN baseband processing circuitry 708a and provide WLAN RF output signals to the FEM circuitry 704a for subsequent wireless transmission by the one or more antennas 701. BT radio IC circuitry 706b may also include a transmit signal path which may include circuitry to up-convert BT baseband signals provided by the BT baseband processing circuitry 708b and provide BT RF output signals to the FEM circuitry 704b for subsequent wireless transmission by the one or more antennas 701. In the embodiment of FIG. 7, although radio IC circuitries 706a and 706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 708a-b may include a WLAN baseband processing circuitry 708a and a BT baseband processing circuitry 708b. The WLAN baseband processing circuitry 708a may include a memory, such as, for example, a set of RAM arrays in a Fast Fourier Transform or Inverse Fast Fourier Transform block (not shown) of the WLAN baseband processing circuitry 708a. Each of the WLAN baseband circuitry 708a and the BT baseband circuitry 708b may further include one or more processors and control logic to process the signals received from the corresponding WLAN or BT receive signal path of the radio IC circuitry 706a-b, and to also generate corresponding WLAN or BT baseband signals for the transmit signal path of the radio IC circuitry 706a-b. Each of the baseband processing circuitries 708a and 708b may further include physical layer (PHY) and medium access control layer (MAC) circuitry, and may further interface with a device for generation and processing of the baseband signals and for controlling operations of the radio IC circuitry 706a-b.

Referring still to FIG. 7, according to the shown embodiment, WLAN-BT coexistence circuitry 713 may include logic providing an interface between the WLAN baseband circuitry 708a and the BT baseband circuitry 708b to enable use cases requiring WLAN and BT coexistence. In addition, a switch 703 may be provided between the WLAN FEM circuitry 704a and the BT FEM circuitry 704b to allow switching between the WLAN and BT radios according to application needs. In addition, although the antennas 701 are depicted as being respectively connected to the WLAN FEM circuitry 704a and the BT FEM circuitry 704b, embodiments include within their scope the sharing of one or more antennas as between the WLAN and BT FEMs, or the provision of more than one antenna connected to each of FEM 704a or 704b. In some embodiments, the front-end module circuitry 704a-b, the radio IC circuitry 706a-b, and baseband processing circuitry 708a-b may be provided on a single radio card, such as wireless radio card 702. In some other embodiments, the one or more antennas 701, the FEM circuitry 704a-b and the radio IC circuitry 706a-b may be provided on a single radio card.

In some other embodiments, the radio IC circuitry 706a-b and the baseband processing circuitry 708a-b may be provided on a single chip or integrated circuit (IC), such as IC 712. In some embodiments, the wireless radio card 702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers. In some of these multicarrier embodiments, radio architecture 105A, 105B may be part of a Wi-Fi communication station (STA) such as a wireless access point (AP), a base station or a mobile device including a Wi-Fi device.

In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards. In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect. In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 9, the BT baseband circuitry 708b may be compliant with a Bluetooth (BT) connectivity standard such as Bluetooth, Bluetooth 7.0 or Bluetooth 8.0, or any other iteration of the Bluetooth Standard. In some embodiments, the radio architecture 105A, 105B may include other radio cards, such as a cellular radio card configured for cellular (e.g., 5GPP such as LTE, LTE-Advanced or 20G communications). In some IEEE 802.11 embodiments, the radio architecture 105A, 105B may be configured for communication over various channel bandwidths including bandwidths having center frequencies of about 900 MHz, 2.4 GHZ, 5 GHZ, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

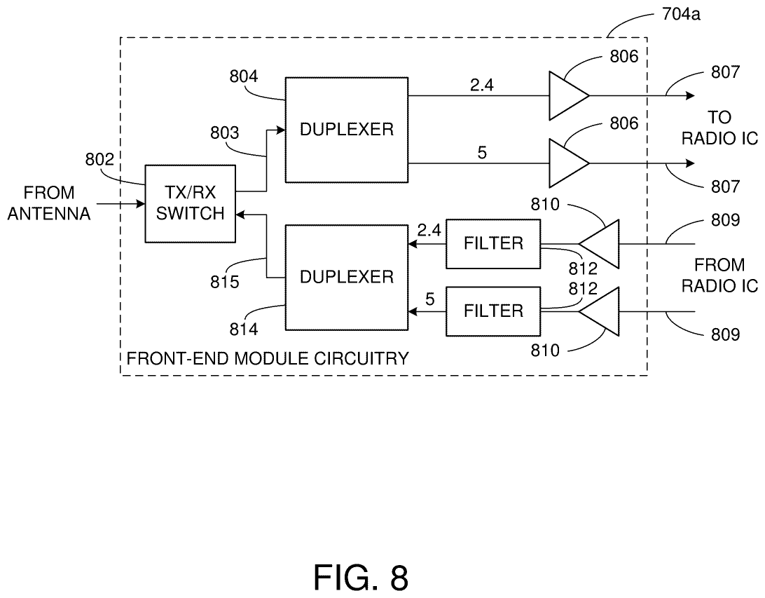

FIG. 8 illustrates WLAN FEM circuitry 704a in accordance with some embodiments. Although the example of FIG. 8 is described in conjunction with the WLAN FEM circuitry 704a, the example of FIG. 8 may be described in conjunction with the example BT FEM circuitry 704b (FIG. 7), although other circuitry configurations may also be suitable. In some embodiments, the FEM circuitry 704a may include a TX/RX switch 802 to switch between transmit mode and receive mode operation. The FEM circuitry 704a may include a receive signal path and a transmit signal path. The receive signal path of the FEM circuitry 704a may include a low-noise amplifier (LNA) 806 to amplify received RF signals 803 and provide the amplified received RF signals 807 as an output (e.g., to the radio IC circuitry 706a-b (FIG. 7)). The transmit signal path of the circuitry 704a may include a power amplifier (PA) to amplify input RF signals 809 (e.g., provided by the radio IC circuitry 706a-b), and one or more filters 812, such as band-pass filters (BPFs), low-pass filters (LPFs) or other types of filters, to generate RF signals 815 for subsequent transmission (e.g., by one or more of the antennas 701 (FIG. 7)) via an example duplexer 814.

In some dual-mode embodiments for Wi-Fi communication, the FEM circuitry 704a may be configured to operate in either the 2.4 GHz frequency spectrum or the 5 GHz frequency spectrum. In these embodiments, the receive signal path of the FEM circuitry 704a may include a receive signal path duplexer 804 to separate the signals from each spectrum as well as provide a separate LNA 806 for each spectrum as shown. In these embodiments, the transmit signal path of the FEM circuitry 704a may also include a power amplifier 810 and a filter 812, such as a BPF, an LPF or another type of filter for each frequency spectrum and a transmit signal path duplexer 804 to provide the signals of one of the different spectrums onto a single transmit path for subsequent transmission by the one or more of the antennas 701 (FIG. 7). In some embodiments, BT communications may utilize the 2.4 GHz signal paths and may utilize the same FEM circuitry 704a as the one used for WLAN communications.

FIG. 9 illustrates radio IC circuitry 706a in accordance with some embodiments. The radio IC circuitry 706a is one example of circuitry that may be suitable for use as the WLAN or BT radio IC circuitry 706a/706b (FIG. 7), although other circuitry configurations may also be suitable. Alternatively, the example of FIG. 9 may be described in conjunction with the example BT radio IC circuitry 706b. In some embodiments, the radio IC circuitry 706a may include a receive signal path and a transmit signal path. The receive signal path of the radio IC circuitry 706a may include at least mixer circuitry 902, such as, for example, down-conversion mixer circuitry, amplifier circuitry 906 and filter circuitry 908. The transmit signal path of the radio IC circuitry 706a may include at least filter circuitry 912 and mixer circuitry 914, such as, for example, up-conversion mixer circuitry. Radio IC circuitry 706a may also include synthesizer circuitry 904 for synthesizing a frequency 905 for use by the mixer circuitry 902 and the mixer circuitry 914. The mixer circuitry 902 and/or 914 may each, according to some embodiments, be configured to provide direct conversion functionality.

The latter type of circuitry presents a much simpler architecture as compared with standard super-heterodyne mixer circuitries, and any flicker noise brought about by the same may be alleviated for example through the use of OFDM modulation. FIG. 9 illustrates only a simplified version of a radio IC circuitry, and may include, although not shown, embodiments where each of the depicted circuitries may include more than one component. For instance, mixer circuitry 914 may each include one or more mixers, and filter circuitries 908 and/or 912 may each include one or more filters, such as one or more BPFs and/or LPFs according to application needs. For example, when mixer circuitries are of the direct-conversion type, they may each include two or more mixers. In some embodiments, mixer circuitry 902 may be configured to down-convert RF signals 807 received from the FEM circuitry 704a-b (FIG. 7) based on the synthesized frequency 905 provided by synthesizer circuitry 904. The amplifier circuitry 906 may be configured to amplify the down-converted signals and the filter circuitry 908 may include an LPF configured to remove unwanted signals from the down-converted signals to generate output baseband signals 907. Output baseband signals 907 may be provided to the baseband processing circuitry 708a-b (FIG. 7) for further processing.

In some embodiments, the output baseband signals 907 may be zero-frequency baseband signals, although this is not a requirement. In some embodiments, mixer circuitry 902 may comprise passive mixers, although the scope of the embodiments is not limited in this respect. In some embodiments, the mixer circuitry 914 may be configured to up-convert input baseband signals 911 based on the synthesized frequency 905 provided by the synthesizer circuitry 904 to generate RF output signals 809 for the FEM circuitry 704a-b. The baseband signals 911 may be provided by the baseband processing circuitry 708a-b and may be filtered by filter circuitry 912. The filter circuitry 912 may include an LPF or a BPF, although the scope of the embodiments is not limited in this respect. In some embodiments, the mixer circuitry 902 and the mixer circuitry 914 may each include two or more mixers and may be arranged for quadrature down-conversion and/or up-conversion respectively with the help of synthesizer 904. In some embodiments, the mixer circuitry 902 and the mixer circuitry 914 may each include two or more mixers each configured for image rejection (e.g., Hartley image rejection).

In some embodiments, the mixer circuitry 902 and the mixer circuitry 914 may be arranged for direct down-conversion and/or direct up-conversion, respectively. In some embodiments, the mixer circuitry 902 and the mixer circuitry 914 may be configured for super-heterodyne operation, although this is not a requirement. Mixer circuitry 902 may comprise, according to one embodiment: quadrature passive mixers (e.g., for the in-phase (I) and quadrature phase (Q) paths). In such an embodiment, RF input signal 807 from FIG. 9 may be down-converted to provide I and Q baseband output signals to be sent to the baseband processor. Quadrature passive mixers may be driven by zero and ninety-degree time-varying LO switching signals provided by a quadrature circuitry which may be configured to receive a LO frequency (fLO) from a local oscillator or a synthesizer, such as LO frequency 905 of synthesizer 904 (FIG. 9). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption. The RF input signal 807 (FIG. 8) may comprise a balanced signal, although the scope of the embodiments is not limited in this respect. The I and Q baseband output signals may be provided to low-noise amplifier, such as amplifier circuitry 906 (FIG. 9) or to filter circuitry 908 (FIG. 9). In some embodiments, the output baseband signals 907 and the input baseband signals 911 may be analog baseband signals, although the scope of the embodiments is not limited in this respect. In some alternate embodiments, the output baseband signals 907 and the input baseband signals 911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect. In some embodiments, the synthesizer circuitry 904 may be a fractional-N synthesizer or a fractional N/N+1 synthesizer, although the scope of the embodiments is not limited in this respect as other types of frequency synthesizers may be suitable. For example, synthesizer circuitry 904 may be a delta-sigma synthesizer, a frequency multiplier, or a synthesizer comprising a phase-locked loop with a frequency divider. According to some embodiments, the synthesizer circuitry 904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 904 may be provided by a voltage controlled oscillator (VCO), although that is not a requirement.

A divider control input may further be provided by either the baseband processing circuitry 708a-b (FIG. 7) depending on the desired output frequency 905. In some embodiments, a divider control input (e.g., N) may be determined from a look-up table (e.g., within a Wi-Fi card) based on a channel number and a channel center frequency as determined or indicated by the example application processor 710. The application processor 710 may include, or otherwise be connected to, one of the example secure signal converter 101 or the example received signal converter 103 (e.g., depending on which device the example radio architecture is implemented in). In some embodiments, synthesizer circuitry 904 may be configured to generate a carrier frequency as the output frequency 905, while in other embodiments, the output frequency 905 may be a fraction of the carrier frequency (e.g., one-half the carrier frequency, one-third the carrier frequency). In some embodiments, the output frequency 905 may be a LO frequency (fLO).

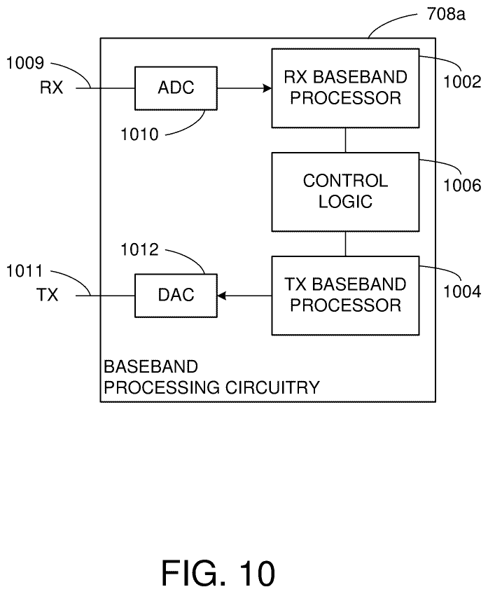

FIG. 10 illustrates a functional block diagram of baseband processing circuitry 708a in accordance with some embodiments. The baseband processing circuitry 708a is one example of circuitry that may be suitable for use as the baseband processing circuitry 708a (FIG. 7), although other circuitry configurations may also be suitable. Alternatively, the example of FIG. 9 may be used to implement the example BT baseband processing circuitry 708b of FIG. 7. The baseband processing circuitry 708a may include a receive baseband processor (RX BBP) 1002 for processing receive baseband signals 909 provided by the radio IC circuitry 706a-b (FIG. 7) and a transmit baseband processor (TX BBP) 1004 for generating transmit baseband signals 911 for the radio IC circuitry 706a-b. The baseband processing circuitry 708a may also include control logic 1006 for coordinating the operations of the baseband processing circuitry 708a.

In some embodiments (e.g., when analog baseband signals are exchanged between the baseband processing circuitry 708a-b and the radio IC circuitry 706a-b), the baseband processing circuitry 708a may include ADC 1010 to convert analog baseband signals 1009 received from the radio IC circuitry 706a-b to digital baseband signals for processing by the RX BBP 1002. In these embodiments, the baseband processing circuitry 708a may also include DAC 1012 to convert digital baseband signals from the TX BBP 1004 to analog baseband signals 1011. In some embodiments that communicate OFDM signals or OFDMA signals, such as through baseband processor 708a, the transmit baseband processor 1004 may be configured to generate OFDM or OFDMA signals as appropriate for transmission by performing an inverse fast Fourier transform (IFFT). The receive baseband processor 1002 may be configured to process received OFDM signals or OFDMA signals by performing an FFT.

In some embodiments, the receive baseband processor 1002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication. Referring back to FIG. 7, in some embodiments, the antennas 701 (FIG. 7) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device including processing circuitry coupled to storage, the processing circuitry configured to: cause to send an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR); and cause to send, based on the UHR variant BSRP trigger frame, a first downlink physical layer protocol data unit (PPDU) in synchronization with a second downlink PPDU of the shared AP.

Example 2 may include the device of example 1 and/or any other example herein, wherein the UHR variant BSRP trigger frame comprises a common info field including a length subfield, and wherein the length subfield indicates a value to be set in a length field of a legacy signal (L-SIG) field of the first downlink PPDU and the second downlink PPDU.

Example 3 may include the device of example 1 and/or any other example herein, wherein the UHR variant BSRP trigger frame includes a common info field comprising a guard interval (GI) and UHR-long training field (UHR-LTF) type subfield, and wherein the GI and UHR-LTF type subfield indicates a GI and a LTF size of the first downlink PPDU and the second downlink PPDU.

Example 4 may include the device of example 3 and/or any other example herein, wherein the GI and UHR-LTF type subfield is set to zero to indicate a 2×LTF plus 0.8 microseconds GI.

Example 5 may include the device of example 3 and/or any other example herein, wherein the GI and UHR-LTF type subfield is set to one to indicate a 2×LTF plus 1.6 microseconds GI.

Example 6 may include the device of example 3 and/or any other example herein, wherein the GI and UHR-LTF type subfield is set to two to indicate a 4×LTF plus 3.2 microseconds GI.

Example 7 may include the device of example 1 and/or any other example herein, wherein the UHR variant BSRP trigger frame includes a common info field comprising a number of UHR-LTF symbols subfield, and wherein the number of UHR-LTF symbols subfield indicates a number of UHR-LTF symbols included in the first CoBF downlink PPDU and the second CoBF downlink PPDU.

Example 8 may include the device of example 1 and/or any other example herein, wherein the UHR variant BSRP trigger frame indicates that the downlink transmissions are to use CoSR, wherein the UHR variant BSRP trigger frame comprises a common info field including an AP transmit (AP TX) power subfield, and wherein the AP TX power subfield indicates a combined TX power of antennas used by the device to transmit the first downlink PPDU.

Example 9 may include the device of example 1 and/or any other example herein, wherein the UHR variant BSRP trigger frame includes a common info field including a multi-AP coordination (MAPC) trigger type subfield, and wherein the MAPC trigger type subfield indicates an MAPC trigger type as CoBF or CoSR mode 1 or CoSR mode 2.

Example 10 may include the device of example 1 and/or any other example herein, wherein the UHR variant BSRP trigger frame indicates: a GI and a high-efficiency (HE)/UHR-LTF type of the first downlink PPDU and the second downlink PPDU; an MAPC trigger type; a CoBF or CoSR synchronization indication; a basic service set (BSS) color 1 and BSS color 2; a block acknowledgement (BA) type for CoSR; a station identifier of a station associated to receive the first downlink PPDU and the second downlink PPDU with transmission parameters for receiving a CoBF PPDU comprise a 2×LDPC (low-density parity check) bit, a 5 bit modulation and coding scheme (MCS), a 4 bit spatial stream configuration, and a 1 bit BSS belonging indication; puncturing channel information; a number of CoBF users; a transmission opportunity (TXOP); a maximum target transmit power for the first downlink PPDU and for the second downlink PPDU; a resource unit (RU) allocation for block acknowledgement feedback as a response to a CoSR transmission; a GI and HE/UHR-LTF type for a trigger-based BA in response to the first downlink PPDU and the second downlink PPDU; and a BSS color of the trigger-based BA.

Example 11 may include the device of example 1 and/or any other example herein, wherein the UHR variant BSRP trigger frame includes a special user information field comprising a universal signal (U-SIG) disregard and validate subfield, and wherein the U-SIG disregard and validate subfield indicates a BSS color of the device, that the first downlink PPDU and the second downlink PPDU are to use CoBF or CoSR, and a number of UHR-SIG symbols in the first downlink PPDU.

Example 12 may include the device of claim 1 and/or any other example herein, further including a transceiver configured to transmit and receive wireless signals comprising the UHR variant BSRP trigger frame and the first downlink PPDU and the second downlink PPDU.

Example 13 may include the device of example 12 and/or any other example herein, further including an antenna coupled to the transceiver to cause to send the UHR variant BSRP trigger frame and the first downlink PPDU and the second downlink PPDU.

Example 14 may include a non-transitory computer-readable medium storing computer-executable instructions which when executed by one or more processors of a device result in performing operations comprising to: cause to send an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR); and cause to send, based on the UHR variant BSRP trigger frame, a first downlink physical layer protocol data unit (PPDU) in synchronization with a second downlink PPDU of the shared AP.

Example 15 may include the non-transitory computer-readable medium of claim 14, wherein the UHR variant BSRP trigger frame includes a common info field including a length subfield, and wherein the length subfield indicates a value to be set in a length field of a legacy signal (L-SIG) field of the first downlink PPDU and the second downlink PPDU.

Example 16 may include the non-transitory computer-readable medium of example 14 and/or any other example herein, wherein the UHR variant BSRP trigger frame includes a common info field including a guard interval (GI) and UHR-long training field (UHR-LTF) type subfield, and wherein the GI and UHR-LTF type subfield indicates a GI and a LTF size of the first downlink PPDU and the second downlink PPDU.

Example 17 may include the non-transitory computer-readable medium of example 14 and/or any other example herein, wherein the UHR variant BSRP trigger frame includes a common info field including a number of UHR-LTF symbols subfield, and wherein the number of UHR-LTF symbols subfield indicates a number of UHR-LTF symbols included in the first downlink PPDU and the second downlink PPDU.

Example 18 may include the non-transitory computer-readable medium of example 14 and/or any other example herein, wherein the UHR variant BSRP trigger frame indicates that the downlink transmissions are to use CoSR, wherein the UHR variant BSRP trigger frame includes a common info field including an AP transmit (AP TX) power subfield, and wherein the AP TX power subfield indicates a combined TX power of antennas used by the device to transmit the first downlink PPDU.

Example 19 may include the non-transitory computer-readable medium of example 14 and/or any other example herein, wherein the UHR variant BSRP trigger frame includes a common info field including a multi-AP coordination (MAPC) trigger type subfield, and wherein the MAPC trigger type subfield indicates an MAPC trigger type as CoBF or CoSR mode 1 or CoSR mode 2.

Example 20 may include a method including: causing to send, by processing circuitry of a sharing access point (AP), an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR) mode 1 or Co-SR mode 2; and causing to send, by the processing circuitry and based on the UHR variant BSRP trigger frame, a first downlink physical layer protocol data unit (PPDU) in synchronization with a second downlink PPDU of the shared AP.

Example 21 may include an apparatus comprising means for performing any of the steps of examples 1-20 and/or any other example herein.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
cause to send an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR); and
cause to send, based on the UHR variant BSRP trigger frame, a first downlink physical layer protocol data unit (PPDU) in synchronization with a second downlink PPDU of the shared AP.

2. The device of claim 1, wherein the UHR variant BSRP trigger frame comprises a common info field comprising a length subfield, and wherein the length subfield indicates a value to be set in a length field of a legacy signal (L-SIG) field of the first downlink PPDU and the second downlink PPDU.

3. The device of claim 1, wherein the UHR variant BSRP trigger frame comprises a common info field comprising a guard interval (GI) and UHR-long training field (UHR-LTF) type subfield, and wherein the GI and UHR-LTF type subfield indicates a GI and a LTF size of the first downlink PPDU and the second downlink PPDU.

4. The device of claim 3, wherein the GI and UHR-LTF type subfield is set to zero to indicate a 2×LTF plus 0.8 microseconds GI.

5. The device of claim 3, wherein the GI and UHR-LTF type subfield is set to one to indicate a 2×LTF plus 1.6 microseconds GI.

6. The device of claim 3, wherein the GI and UHR-LTF type subfield is set to two to indicate a 4×LTF plus 3.2 microseconds GI.

7. The device of claim 1, wherein the UHR variant BSRP trigger frame comprises a common info field comprising a number of UHR-LTF symbols subfield, and wherein the number of UHR-LTF symbols subfield indicates a number of UHR-LTF symbols included in the first CoBF downlink PPDU and the second CoBF downlink PPDU.

8. The device of claim 1, wherein the UHR variant BSRP trigger frame indicates that the downlink transmissions are to use CoSR, wherein the UHR variant BSRP trigger frame comprises a common info field comprising an AP transmit (AP TX) power subfield, and wherein the AP TX power subfield indicates a combined TX power of antennas used by the device to transmit the first downlink PPDU.

9. The device of claim 1, wherein the UHR variant BSRP trigger frame comprises a common info field comprising a multi-AP coordination (MAPC) trigger type subfield, and wherein the MAPC trigger type subfield indicates an MAPC trigger type as CoBF or CoSR mode 1 or CoSR mode 2.

10. The device of claim 1, wherein the UHR variant BSRP trigger frame indicates:
a GI and a high-efficiency (HE)/UHR-LTF type of the first downlink PPDU and the second downlink PPDU;
an MAPC trigger type;
a CoBF or CoSR synchronization indication;
a basic service set (BSS) color 1 and BSS color 2;
a block acknowledgement (BA) type for CoSR;
a station identifier of a station associated to receive the first downlink PPDU and the second downlink PPDU with transmission parameters for receiving a CoBF PPDU comprise a 2×LDPC (low-density parity check) bit, a 5 bit modulation and coding scheme (MCS), a 4 bit spatial stream configuration, and a 1 bit BSS belonging indication;
puncturing channel information;
a number of CoBF users;
a transmission opportunity (TXOP);
a maximum target transmit power for the first downlink PPDU and for the second downlink PPDU;
a resource unit (RU) allocation for block acknowledgement feedback as a response to a CoSR transmission;
a GI and HE/UHR-LTF type for a trigger-based BA in response to the first downlink PPDU and the second downlink PPDU; and
a BSS color of the trigger-based BA.

11. The device of claim 1, wherein the UHR variant BSRP trigger frame comprises a special user information field comprising a universal signal (U-SIG) disregard and validate subfield, and wherein the U-SIG disregard and validate subfield indicates a BSS color of the device, that the first downlink PPDU and the second downlink PPDU are to use CoBF or CoSR, and a number of UHR-SIG symbols in the first downlink PPDU.

12. The device of claim 1, further comprising a transceiver configured to transmit and receive wireless signals comprising the UHR variant BSRP trigger frame and the first downlink PPDU and the second downlink PPDU.

13. The device of claim 12, further comprising an antenna coupled to the transceiver to cause to send the UHR variant BSRP trigger frame and the first downlink PPDU and the second downlink PPDU.

14. A non-transitory computer-readable medium storing computer-executable instructions which when executed by one or more processors of a device result in performing operations comprising to:
cause to send an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR); and
cause to send, based on the UHR variant BSRP trigger frame, a first downlink physical layer protocol data unit (PPDU) in synchronization with a second downlink PPDU of the shared AP.

15. The non-transitory computer-readable medium of claim 14, wherein the UHR variant BSRP trigger frame comprises a common info field comprising a length subfield, and wherein the length subfield indicates a value to be set in a length field of a legacy signal (L-SIG) field of the first downlink PPDU and the second downlink PPDU.

16. The non-transitory computer-readable medium of claim 14, wherein the UHR variant BSRP trigger frame comprises a common info field comprising a guard interval (GI) and UHR-long training field (UHR-LTF) type subfield, and wherein the GI and UHR-LTF type subfield indicates a GI and a LTF size of the first downlink PPDU and the second downlink PPDU.

17. The non-transitory computer-readable medium of claim 14, wherein the UHR variant BSRP trigger frame comprises a common info field comprising a number of UHR-LTF symbols subfield, and wherein the number of UHR-LTF symbols subfield indicates a number of UHR-LTF symbols included in the first downlink PPDU and the second downlink PPDU.

18. The non-transitory computer-readable medium of claim 14, wherein the UHR variant BSRP trigger frame indicates that the downlink transmissions are to use CoSR, wherein the UHR variant BSRP trigger frame comprises a common info field comprising an AP transmit (AP TX) power subfield, and wherein the AP TX power subfield indicates a combined TX power of antennas used by the device to transmit the first downlink PPDU.

19. The non-transitory computer-readable medium of claim 14, wherein the UHR variant BSRP trigger frame comprises a common info field comprising a multi-AP coordination (MAPC) trigger type subfield, and wherein the MAPC trigger type subfield indicates an MAPC trigger type as CoBF or CoSR mode 1 or CoSR mode 2.

20. A method comprising:
causing to send, by processing circuitry of a sharing access point (AP), an ultra high reliability (UHR) variant buffer status report poll (BSRP) trigger frame indicating that the device and a shared access point (AP) are to coordinate downlink transmissions, wherein the UHR variant BSRP trigger frame indicates that the downlink transmissions are to use coordinated beamforming (CoBF) or coordinated spatial reuse (CoSR) mode 1 or Co-SR mode 2; and
causing to send, by the processing circuitry and based on the UHR variant BSRP trigger frame, a first downlink physical layer protocol data unit (PPDU) in synchronization with a second downlink PPDU of the shared AP.
